(19) United States
(12) Patent Application Publication
(10) Pub. No.: US 2024/0012119 A1
(43) Pub. Date: Jan. 11, 2024

(54) TIME-OF-FLIGHT CIRCUITRY AND TIME-OF-FLIGHT METHOD

(71) Applicant: Sony Semiconductor Solutions Corporation, Atsugi-shi, Kanagawa (JP)

(72) Inventors: Maarten KUIJK, Stuttgart (DE); Daniel VAN NIEUWENHOVE, Stuttgart (DE)

(73) Assignee: Sony Semiconductor Solutions Corporation, Atsugi-shi, Kanagawa (JP)

(21) Appl. No.: 18/022,294

(22) PCT Filed: Aug. 27, 2021
(86) PCT No.: PCT/EP2021/073708

§ 371 Date: Feb. 21, 2023

(30) Foreign Application Priority Data
Aug. 31, 2020 (EP) 20193730.7

(51) Int. Cl. G01S 7/4865; G01S 7/481; G01S 17/931

(52) U.S. Cl. CPC G01S 7/4865; G01S 7/4816; G01S 17/931

(57) ABSTRACT

The present disclosure generally pertains to time-of-flight circuitry configured to: obtain an avalanche signal, which is representative of a light detection event; and process the avalanche signal on the basis of at least one alternating demodulation signal for correlating the avalanche signal with the light detection event.

### TECHNICAL FIELD

The present disclosure generally pertains to time-of-flight circuitry and a time-of-flight method.

### TECHNICAL BACKGROUND

Generally, Single Photon Avalanche Detectors (SPADs) are known. Besides being capable to detect single photons, SPADs have the, inherent property that a time of a photon being incident on the SPAD is known. Hence, SPADS can be used for distance detection, e.g. for lidar and 3D camera applications, or generally in time-of-flight (TOF) devices.

Generally, for known TOF devices, one technology, which is applied is indirect TOF (iTOF), in which a phase shift of emitted light with respect to detected light is determined in order to measure a distance between the TOF device and the scene. In iTOF, detected light is processed based on demodulation functions (typically four demodulation functions, but also more or less can be used), for measuring incident light on (typically) a CAPD (Current assisted photonic demodulator). Time-windows in which the light is detected are measured with the help of the demodulation functions, and the phase-shift results from an arctangent relation with the respective time-windows. This is also known as I and Q demodulation.

Another TOF technology is known as direct TOF (dTOF), in which a roundtrip delay (i.e. the literal time of flight) of the emitted and reflected light is measured. Typically, SPADs are applied for detecting light events, wherein the time of these light events are stored in a histogram, which in turn is being read out. Based on the speed of light, the distance can then be calculated.

Although there exist TOF devices, it is generally desirable to provide time-of-flight circuitry and a time-of-flight method,

### SUMMARY

According to a first aspect ,the disclosure provides time-of-flight circuitry configured to: obtain, an avalanche signal, which is representative of a light detection event; and process the avalanche signal on the basis of at least one alternating demodulation signal for correlating the avalanche signal with the light detection event.

According to a second aspect, the disclosure provides a time-of-flight method comprising: obtaining an avalanche signal, which is representative of a light detection event; and processing the avalanche signal on the basis of at least one alternating demodulation signal for correlating the avalanche signal with the light detection event.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 shows an embodiment of time-of-flight circuitry (a TOF receiver) according to the present disclosure with a SPAD circuit, a switch control circuit and two averaging demodulators driven by the switch control circuit;

FIG. 2 shows transient signals of an operation of the time-of-flight circuitry of FIG. 1, thereby demonstrating the use of sine and cosine demodulation functions;

FIG. 3 zooms in on some of the signals around the event at ninety-six nanoseconds of FIG. 2;

FIG. 4 shows a further embodiment of time-of-flight circuitry (a TOF receiver) according to the present disclosure implementing a single averaging demodulator;

FIG. 5 shows a simulation with a sample averaging length of ten that has run for sixty events, of which six events are DCR+BL events and fifty-four events are TOF events;

FIG. 6 shows a simulation with a sample averaging length of two hundred that has run for eight hundred events, of which seven hundred and twenty events are DCR+BL events and eighty are TOF events;

FIG. 7 shows a further embodiment of time-of-flight circuitry (a TOF receiver) according to the present disclosure defining two time windows based on two gating circuits of which the first gating circuit is passing the events from the SPAD circuit to the averaging demodulators when the signal on a first input node is high, and the second gating circuit is passing the events from the SPAD circuit to the averaging demodulators when the signal on a second input node is high;

FIG. 8 shows the transient signals in a case where the time domain after scene illumination light source pulses is split into two equal length, non-overlapping parts, by driving the first input node of FIG. 7 with a signal and the second input node of FIG. 7 with another signal;

FIG. 9 shows the transient signals in a case where the time domain after scene illumination light source pulses is split into three equal parts with five nanoseconds overlap for each part with three different signals;

FIG. 10 shows an example of alternative demodulation functions being triangular demodulation functions for achieving comparable results as with the sine and cosine functions, thereby simplifying the generation of the demodulation functions and the post-calculations for TOF estimation;

FIG. 11 shows four demodulation functions that can be operated on four averaging demodulators simultaneously and in parallel, with a sine and a cosine demodulation function and with additional sine and cosine demodulation functions having a four times higher frequency;

FIG. 12 shows examples of alternative demodulation functions that when connected to averaging demodulators make them reveal in which subspace Q1, Q2, Q3 or Q4 in time the TOF arrival events reside;

FIG. 13 shows a further embodiment of a TOF receiver according to the present disclosure having two SPAD circuits operating each with their own switch control circuit and averaging demodulators, but simultaneously operating on a single averaging output node;

FIG. 14 shows a further embodiment of a TOF receiver based on the present disclosure having an additional analog photon counter with an asynchronous reset input using signals from the switch control circuit that are readily available for the averaging demodulator;

FIG. 15 embodies a TOF receiver 91 of the present disclosure integrated with a row line and a column line for array integration;

FIG. 16 is a block diagram depicting an example of schematic configuration of a vehicle control system;

FIG. 17 is a diagram of assistance in explaining an example of installation positions of an outside-vehicle information detecting section and an imaging section;

FIG. 18 depicts an embodiment of a time-of-flight camera;

FIG. 19 depicts a block diagram of a time-of-flight method according to the present disclosure; and

FIG. 20 depicts an illustration for a calculation of a distance according to the present disclosure.

### DETAILED DESCRIPTION OF EMBODIMENTS

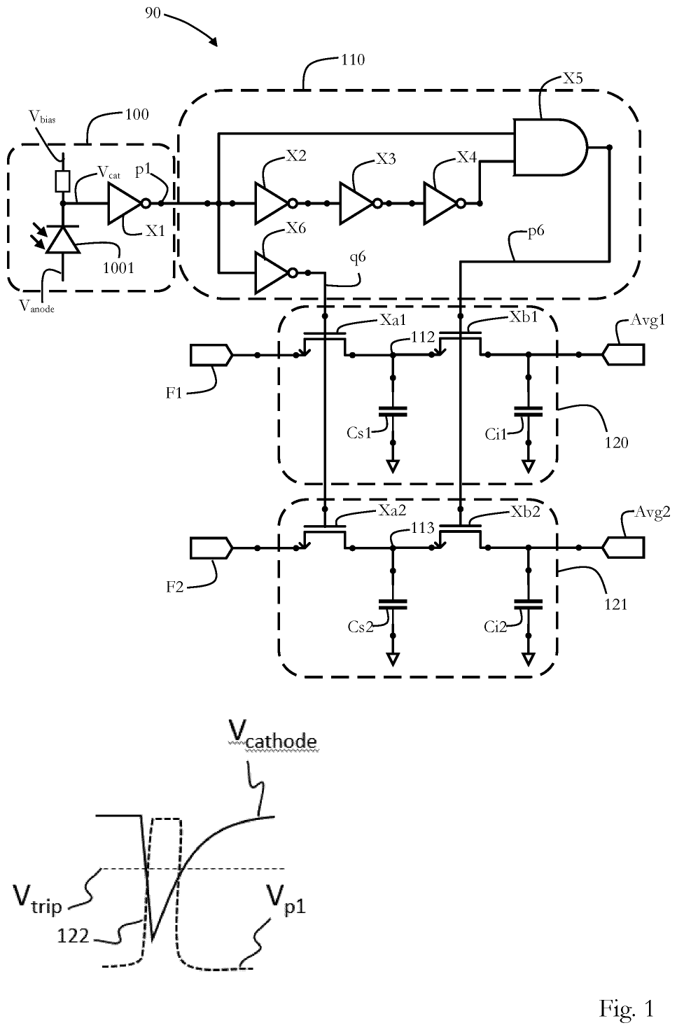

Before a detailed description of the embodiments under reference of FIG. 1 is given, general explanations are made.

The present disclosure will be described with respect to particular embodiments and with reference to certain drawings, but the disclosure is not limited thereto. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the disclosure. In the different figures, the same reference numbers refer to the same or analogous elements, wherein a repetitive explanation of the same elements is omitted in such cases.

It is to be noticed that, the term “comprising”, used in the claims, should not be interpreted as being restricted to the means listed thereafter. Thus, the scope of the expression “a device comprising means A and B” should not be limited to devices consisting only of components A and B.

Similarly, it is to be noticed that the term “coupled” should not be interpreted as being restricted to direct connections only. Thus, the scope of the expression “a device A coupled to a device B” should not be limited to devices or systems wherein an output of device A is directly connected to an input of device B. It means that there exists a path between an output of A and an input of B which may be a path including other devices or means.

As mentioned in the outset, TOF devices are generally known. iTOF (indirect Time-of-Flight) is typically based on CAPD (Current Assisted Photonic Demodulator) technology using demodulation functions for determining a phase shift, whereas dTOF (direct Time-of-Flight) is typically based on SPAD (Single Photon Avalanche Detector) technology using histograms in order to determine the time of flight.

However, it has been recognized that the usage of histograms may typically result in complex readout circuitry and it may be generally desirable to reduce circuitry, such that for example smaller TOF devices may be produced and costs may be reduced.

Hence, it has been recognized that it may be desirable in some instances to abstain from the usage of histograms.

Moreover, although iTOF requires less operating power than dTOF in some instances, iTOF may be less optically sensitive than dTOF. However, dTOF may have a lower resolution due to its pixel size and its complexity.

Hence, it has been recognized that in some instances it may be desirable to have (at least partially) advantages of both technologies.

Moreover, it has been recognized that SPADs may also trigger on thermally generated, statistically distributed, minority carriers, in the semiconductor, or on tunneling of carriers, also called dark counts and expressed as a dark count rate (DCR).

When light is incident on a TOF receiver (e.g. a SPAD), typically, there are different origins of the light, e.g. correlated photons (TOF photons) stemming from a reflection in the scene of a pulsed laser light source, or uncorrelated photons from background light (BL) reflected on the target area in the scene. Making a histogram of the arrival times, typically results in a constant level for the sum of BL and DCR, and a peak based on the correlated TOF photons.

For a small number of pixels (e.g. a linear array of pixels, or for a limited resolution array of pixels), the negative effect of BL and DCR may be neglected or even removed. For example, the moment in time may be recorded by using counters to achieve time to digital conversion (TDC), and this data may be communicated to a digital signal processor (DSP) to achieve histogram build-up and finally a threshold may be applied for estimating the TOF distance. When scaling to higher resolutions (i.e. more pixels) and/or high BL levels, data-congestion and higher power dissipation may become problematic in some instances.

Therefore, it has been recognized that this might be overcome by providing circuitry and a method in the field of 3D image sensing using single photon detection, signal demodulation and local averaging on a per pixel base.

Generally, an effect according to the present disclosure may be, in some instances, that corresponding circuits can be made particularly small (compared to known TOF circuits), such that they may be placed in array format to constitute a high-resolution imaging sensor.

Therefore, some embodiments pertain to time-of-flight circuitry configured to: obtain an avalanche signal, which is representative of a light detection event; and process the avalanche signal on the basis of at least one alternating demodulation signal for correlating the avalanche signal with the light detection event.

The time-of-flight circuitry may include any circuitry which is configurable to evaluate a time-of-flight signal, in particular, an avalanche signal according to the present disclosure, such as a CPU (central processing unit), GPU (graphic processing unit), an FPGA (field programmable gate array), or any other (micro)processor known in the art. Also, combinations of above-named elements may be envisaged by a person skilled in the art, such as a combination of two CPUs, a CPU and a GPU, and so on. Moreover, time-of-flight circuitry according to the present disclosure may pertain to any electronic device, such as a camera (e.g. a time-of-flight camera), a smartphone or any other portable device, a personal computer, a server, or combinations thereof, etc., as it is generally known, and, generally, the time-of-flight circuitry may be implemented in any such device or any other device/apparatus including automotive applications, consumer electronic applications, medical applications, industrial applications, etc., without limiting the present disclosure in that regard.

With such time-of-flight circuitry, a small circuit may be provided, which can be integrated on a per pixel base (for example), and that demodulates and averages incoming events.

According to the present disclosure, in some embodiments, it may be possible to get two voltages that allow for example to estimate the time of flight and a confidence of the outcome. This may be achieved with an accuracy and precision depending on the signal to noise ratio and on the averaging length. Signal to noise ratio (SNR) can be defined as the number of TOF events per number of background light (BL) and dark count rate (DCR) events, for example.

In some embodiments, by processing the (light detection) events locally, power dissipation remains limited, and data traffic congestion gets avoided. Further, a large dynamic range of incident light powers gets supported, in some embodiments, without requiring pre-knowledge of the incident light intensity levels. Arrays of pixels of the present disclosure may be read-out asynchronously, for example, without the need of stopping nor resetting the local averaging. The averaging in each pixel (i.e. in each time-of-flight circuitry according to the present disclosure in case there are multiple time-of-flight circuitries) can further be complemented with data communication to a DSP with a comparable image data transfer rate as with standard 2D image sensors, for example. Compared to other systems of signal demodulation in pixels (e.g. a CAPD), it may not be required, according to some embodiment of the present disclosure, to work with different measurement frames that each need to be recorded consecutively. All averaged demodulation voltages may be measured/acquired simultaneously, such that high-speed distance tracking and operation with comparably low light input levels are possible.

Moreover, a system may be provided based on the time-of-flight circuitry according to the present disclosure that can be used in 3D-TOF image sensors that are fabricated with a single layer of electronics, but that is also highly desirable in a 3D-stacked configuration, whereby several semiconductor layers are stacked for different functionality, like a detection layer for SPADs and a layer for the subsequent data processing in some embodiments.

The avalanche signal may be a signal being generated in response to a light detection event. For example, a single photon or a plurality of photons being incident on a light event detector (e.g. a SPAD (single photon avalanche diode), an avalanche photodiode) may serve as the light detection event, thereby leading to a change (e.g. a drop or a rise) of voltage in the light event detector.

Typically, as it is generally known in the field of time-of-flight, any light detection event may cause an avalanche signal. However, a time-of-flight device (e.g. a camera) or a standalone light source may be configured to emit pulsed light, which is reflected at a scene (e.g. an object) and which is then measured at the light event detector. In such instances, it may be desired to determine the time, which the light needs from its emission to its detection (i.e. the time of flight or roundtrip delay), thereby indicating the distance to the scene.

To such known time-of-flight methods, it is typically referred to as direct time-of-flight (dToF) in the art. In known dToF devices, the generated events may be counted and saved in a histogram, which is read out in order to determine the roundtrip delay.

However, according to the present disclosure, the avalanche signal maybe processed on the basis of at least one alternating demodulation signal.

In this context, alternating may include that at least two different, repetitive values of the demodulation signal (e.g. a voltage value or voltage level) may be present during one processing period (i.e. a period of time in which the avalanche signal is correlated with the light detection event).

Moreover, the alternating signal may have an offset, such that an alternation is not limited to a polarity change of the signal.

For example, the at least one demodulation signal may be periodic (e.g. a rectangular function, a sine function, or the like). In the case that there are multiple demodulation signals present, it may be envisaged that the demodulation signals may be based on different functions. For example, a first demodulation signal may be based on a sine function, and a second demodulation signal may be based on a rectangular function, without limiting the present disclosure in that regard. Of course, this may also be extended to embodiments with more than two demodulation signals (e.g. in the case of three demodulation signals, three different functions may be used and/or three different phase shifts may be used or a mixture thereof).

The avalanche signal (or a modified version of the avalanche signal, e.g. filtered, smoothed, transformed, and/or the like) may be superposed with the at least one demodulation signal. Due to a change of the demodulation signal, a point of time at which the (modified) avalanche signal is superposed with the at least one demodulation signal may be determined. Taking into account respective delays the avalanche signal may be correlated with the light detection event. For example, a delay between a point of time of the generation of the avalanche signal and a point of time of the light detection event may be known (e.g. due to calibration). Alternatively, the avalanche signal may be superposed with the at least one demodulation signal and a delay between the superposed signal and the light detection signal may be known (e.g. due to calibration), such that the point of time of the light detection event may be derived.

In other words: A point of time at which the light is incident on, the light event detector may be determined by superposing the avalanche signal with the at least one demodulation signal. Since a timing of the at least one demodulation signal can be adjusted, (roughly) exact points of time can be determined by reading out the at least, one demodulation signal. Thereby, the point of time (or a time interval) of the light detection event can be determined by detecting a point of time of a change in the at least one demodulation signal.

In some embodiments, the time-of-flight circuitry is further configured to: save a point of time of the light detection event as a voltage.

For example, the avalanche signal may be based on a voltage drop, as already discussed above. Hence, a voltage signal may be generated in response to the light detection event. In order to superpose the avalanche signal with the at least one demodulation signal, the at least one demodulation signal may be based on a voltage signal, as well.

Hence, a change in the voltage of the at least one demodulation signal based on the avalanche signal may be detected and saved in, a voltage storage, e.g. digitally or analogously.

For example, the voltage (e.g. voltage value or level) may be saved in at least one capacitor. Reading out a voltage curve of the at least one capacitor (e.g. a voltage saved in the capacitor over time), the point of time of the light detection event may be determined. For example, every time a change of the at least one demodulation signal is detected, a voltage of the at least one capacitor may be adapted, such that the point of time of the light detection event may be indicated by a voltage adaptation in the capacitor (taking into account respective delays).

Moreover, in a case of two (or more) demodulation signals, two (or more) capacitors may save respective voltages in which the two (or more) demodulation signals are changed due to the avalanche signal. Thereby, the point of time of the light detection event may be determined more exactly.

In some embodiments, the voltage is saved in a first capacitor in response to a shorting of the first capacitor with a second capacitor for reducing a noise of the avalanche signal (the first and second capacitor are part of the time-of-flight circuitry in some embodiments).

For example, the avalanche signal may be superposed twice with the demodulation signal. Based on a first superposing, the resulting signal may be fed to the second capacitor. However, the second capacitor may have a lower capacitance than the first capacitor (e.g. a hundred times lower). After that, a short circuit between the first capacitor and the second capacitor may be established, thereby feeding, in a parallel signal line, the avalanche signal to the already superposed demodulation/avalanche signal (previously named as the resulting signal), and at the same time draining the second capacitor by the first capacitor. Thereby, a dark current of the avalanche signal is reduced.

In some embodiments, the at least one demodulation signal includes a first and a second demodulation signal, which can be phase-shifted with respect to each other.

For example, as already discussed, the at least one demodulation signal may be based on a sine function. However, due to the periodicity, it may be the case that the same voltage value may be assigned to the same point of time, thereby leading to a potential ambiguity in determining the point of time at which the at least one demodulation signal changes due to the avalanche signal.

This correct point of time may be determined by introducing a demodulation signal which is phase shifted with respect to the sine function.

For example, the first demodulation signal may be based on a sine function and the second demodulation signal may be based on a cosine function, without limiting the present disclosure in that regard since also rectangular functions, sawtooth functions, triangular functions, and the like may be the basis for the first and the second demodulation signal.

Hence, the avalanche signal may be superposed with the first and the second demodulation signal. The respective superposed signals may, however, look different, due to the phase shift of the first and the second demodulation signal. By comparing the respective superposed signal in terms of the determination of the voltages of the respective capacitors (as discussed above), it is possible to provide a more exact determination of the point of time of the light detection event than with only one demodulation signal.

In some embodiments, the first and the second demodulation signal are based on a trigonometric function.

In such embodiments, any superposed trigonometric function or any function which can be described based on trigonometric functions (e.g. a rectangular function, or the like) may be envisaged, which lies beyond the pure use of sine and cosine functions. In such embodiments, the trigonometric function may be chosen in a way that it allows to reduce (or completely prevent) above-described ambiguity.

In some embodiments, the first and the second demodulation signal are applied simultaneously. For example, if a sine and cosine function are used, they may be applied to the same avalanche signal in parallel circuits, wherein these circuits may be similar to each other for having a comparable determination of the point of time, such that an above-described ambiguity may filtered out.

In some embodiments, the first and the second demodulation signal are applied consecutively. This may be the case, when only one circuit in which the avalanche signal is overlapped with the respective demodulation signals is present. In order to filter out above-described ambiguity, it may be envisaged that the avalanche signal is superposed with the first demodulation signal and also fed parallelly to a delay circuit for superposing it with the second demodulation signal after the first demodulation signal.

In some embodiments, the at least one alternating demodulation signal includes a periodic demodulation signal, as discussed herein.

In some embodiments, the time-of-flight circuitry is further configured to: process the avalanche signal based on a windowing. For example, the windowing may be performed such that a first part of the avalanche signal is processed in a first window and a second part of the avalanche signal is processed in a second window, which will be discussed further below. Moreover, the windowing may be performed with a single window.

In some embodiments, the light detection event is indicative of a point of time of light being incident on a light event detector, as discussed herein.

Some embodiments pertain to a time-of-flight method including: obtaining an avalanche signal, which is representative of a light detection event; and processing the avalanche signal on the basis of at least one alternating demodulation signal for correlating the avalanche signal with the light detection event.

The time-of-flight method may be carried out with time-of-flight circuitry according to the present disclosure or may be implemented as a computer program, and, thus, the explications made with respect to the time-of-flight circuitry also apply to the time-of-flight method.

In some embodiments, the time-of-flight method further includes: saving a point of time of the light detection event as a voltage, as discussed herein. In some embodiments, the voltage is saved in at least one capacitor, as discussed herein. In some embodiments, the voltage is saved in a first capacitor in response to a shorting of the first capacitor with a second capacitor for reducing a noise of the avalanche signal, as discussed herein. In some embodiments, the at least one demodulation signal includes a first and a second demodulation signal, which are phase-shifted with respect to each other. In some embodiments, the first and the second demodulation signal are based on a trigonometric function, as discussed herein. In some embodiments, the first and the second demodulation signal are applied simultaneously, as discussed herein. In some embodiments, the first and the second demodulation signal are applied consecutively, as discussed herein. In some embodiments, the at least one alternating demodulation signal includes a periodic demodulation signal, as discussed herein. In some embodiments, the time-of-flight method further includes: processing the avalanche signal based on a windowing, e.g. with a single window or such that a first part of the avalanche signal is processed in a first window and a second part of the avalanche signal is processed in a second window, as discussed herein.

In some embodiments, the light detection event is indicative of a point of time of light being incident on a light event detector, as discussed herein.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

Some embodiments pertain to a time-of-flight receiver for estimation of a distance including a SPAD circuit for generating an event upon detection of a photon, a switch control circuit for generating a first signal for sampling a modulation voltage, a second signal for including the sample into an average output; and an averaging demodulator, that has a demodulation voltage applied at its input node that in response to the first signal samples this demodulation voltage and that in response to the second signal includes this sample in its output voltage on an output node for estimation of a TOF-distance. In other embodiments, a gating circuit is put in place that inhibits the inclusion of samples in the output voltage during periods determined by a signal on an input node.

To such embodiments, it will further be referred to in the following description of the figures.

Returning to FIG. 1, there is depicted time-of-flight circuitry 90 (also referred to as TOF receiver) according to the present disclosure including a SPAD circuit 100 configured to drive a switch control circuit 110 which in turn is configured to drive averaging demodulators 120 and 121.

The SPAD circuit 100 includes at least a detector adapted to generate a pulse V_{cat} which is representative of a voltage on a node of a cathode of a SPAD 1001 (single photon avalanche detector) in response to an incident photon on the SPAD 1001.

Generally, a solution, is to use a SPAD detector, which may be implemented as an avalanche photodetector (ADP) that is biased above a breakdown voltage by applying voltages on nodes V_{bias} and V_{anode} having a voltage difference larger than the breakdown voltage of the SPAD 1001. As an example which is implemented in this embodiment, for the SPAD 1001 operating with a breakdown voltage of twenty-one volts, the voltage on node V_{bias} can be three volts, and that of node V_{anode} minus twenty volts, totaling twenty-three volts over the SPAD when no current is flowing. The excess bias voltage is then two volts. When a photon is incident that gets detected (for example, not all photons may get detected, in some embodiments) a negative pulse V_{cathode} on a cathode of the SPAD 1001 will occur bringing the voltage over the SPAD detector below or at breakdown (in the example from three volts to one volt).

The circuit shown inside the SPAD circuit 100, has also an inverter X1 with tripping level Vₜᵣᵢₚ for making a digital output on node p1. An output signal Vₚ₁ (as shown in the lower part of FIG. 1) is a positive pulse on the node p1 and to a positive edge of a signal 122 it will further be referred to as an event (which is alight detection event as referred to in this disclosure).

In some embodiments, more complex circuits can be integrated into the SPAD circuit 100, e.g. including but not limited to, having a functionality of auto-quenching, pulse shaping and/or modulation of the detector biasing. All that is needed for the operation of time-of-flight circuitry according to the present disclosure in some embodiments is to have a rising output edge 122 on p1 that is indicative for the time of a photon being incident on the SPAD 1001. Throughout the description of embodiments, an event concerns this rising edge 122 on p1, however in practice a negative edge could alternatively also be defined as the event, if preferred, as will be appreciated by a person skilled in the art. Moreover, generally, the present disclosure is not limited to the concept of rising or falling edge of a pulse, but, for instance, a peak detection of a signal may also be referred to as a (light detection) event (only to mention a further example and without limiting the present disclosure in that regard).

The SPAD 1001 will further have dark counts, as generally known: these are spontaneous events due to dark current that may also generate similar edges. However, these edges will happen typically at random moments in time and are therefore obscuring the events originating from incident photons. The rate at which these events happen is called the Dark Count Rate (DCR). In some embodiments of the present disclosure, a rising edge 122 at the output of the SPAD circuit 100 indicates an event, be it originating from a photon or from a DCR event. A falling edge of the pulse Vₚ₁ on node p1 may be considered less informative and may come a variable time after the rising edge 122, being dependent on implementation of specific elements of the SPAD circuit 100. This pulse, with its timing information being indicated in the rising edge 122, is passed-on to the switch control circuit 110 through the voltage Vₚ₁ on node p1.

In some embodiments, the SPAD Circuit 100 could also contain an avalanche photo-detector (APD) that is biased below breakdown and having such an inherent high gain that a similar digital pulse can be constructed on the digital output node p1, also generating an rising output edge 122 on p1 that is indicative for the time of arrival of a photon.

The switch control circuit 110 of the present embodiment outputs at least two signals. A first signal on a node q6 is provided for driving switches Xa1 and Xa2 (being implemented as transistors in this embodiment) in the attached averaging demodulators 120 and 121, for sampling on nodes Vs1 and Vs2 (roughly) synchronously with demodulation voltages applied at inputs F1 and F2 of the averaging demodulators 120 and 121, respectively, at each event. A second signal on a node p6 is a signal for driving switches Xb1 and Xb2 that causes that the sampled voltages on nodes Vs1 and Vs2 get accounted for in an output average voltage on output nodes Avg1 and Avg2 of the averaging demodulators 120 and 121, respectively, by making the switches Xb1 and Xb2 conductive after the sampling operation for a predetermined period of time. The sampled voltages on nodes F1 and F2 are stored on capacitors Cs1 and Cs2, and the averaged voltages are stored on capacitors Ci1 and Ci2, which are respectively coupled to the output nodes Avg1 and Avg2.

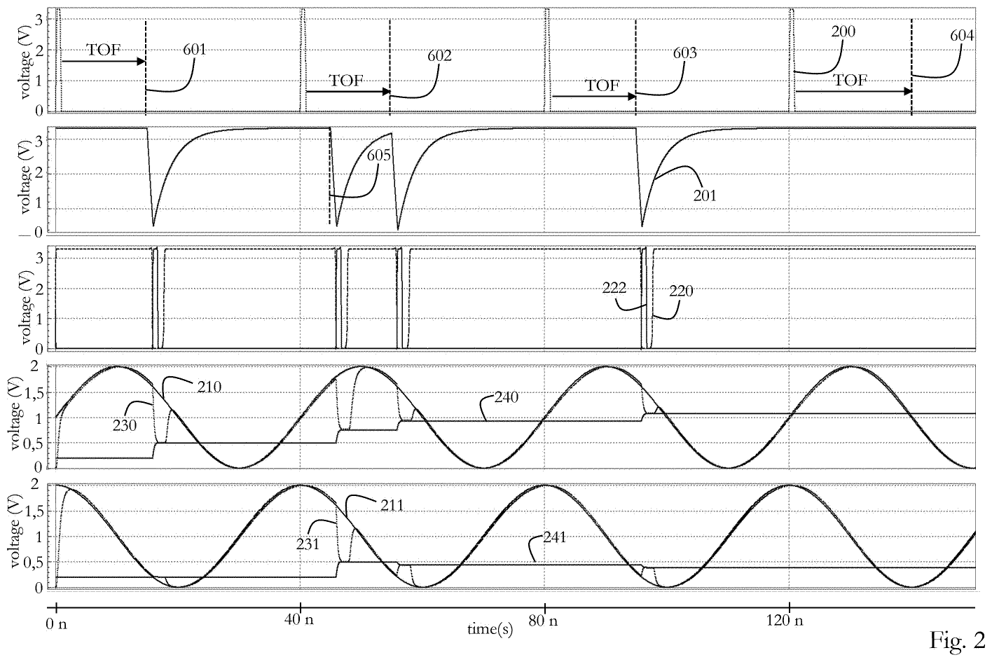

FIG. 2 shows an operation based on a SPICE (Simulation program with integrated circuit emphasis) transient simulation. Curve 200 represents scene illumination light source pulses that are repeated every 40 ns, thus with a pulse repetition rate of 25 MHz in this embodiment.

This light is pulse-wise illuminating the scene, and (some of) the reflected light will be received by the SPAD circuit 100. The scene illuminating light source can be of any type that can generate short light pulses, like LEDs or LASERs. With a delay represented by the time-of-flight (TOF), it becomes possible at moments 601, 602, 603 and 604 that events will be triggered as shown by a dip in a cathode voltage of the SPAD, curve 201. When an event is triggered due to a TOF photon, it is herein referred to as a TOF event. Further, since the reflected light from the scene may be very faint, only few photons may reach the SPAD circuit 100, and only a fraction of these may trigger a TOF event. Curve 201 shows only three events, at moments 601, 602 and 603 that are triggered after a TOF delay, and, thus, can be TOF events. At the fourth moment 604, there is no response in this example (although it might be expected). Further, there can be photons stemming from ambient light, or background light (BL) that can generate events at random times, if they are incident on the SPAD 1001, uncorrelated with the timing of the emitted light pulses 200. Also, the SPAD circuit 100 may generate dark count rate (DCR) events, also at random times. At moment 605, an event occurs, of which one can't tell whether it originates from BL or from DCR.

In the example of FIG. 2, the demodulation functions are based on sine and cosine voltages 210 and 211 which are applied on the inputs F1 and F2 of the averaging demodulators 120 and 121, respectively. To keep it in a single power supply voltage domain, the sine and cosine voltages have a positive one volt offset and they have an amplitude of one volt (in other words: they both oscillate between 0 and 2V) (without limiting the present disclosure in that regard).

At every event, the switch control circuit 100 causes the voltage on node q6 to go low for a predetermined period of time. Until then, the signals 230 and 231 follow their respective voltages on nodes F1 and F2, curves 210 and 211.

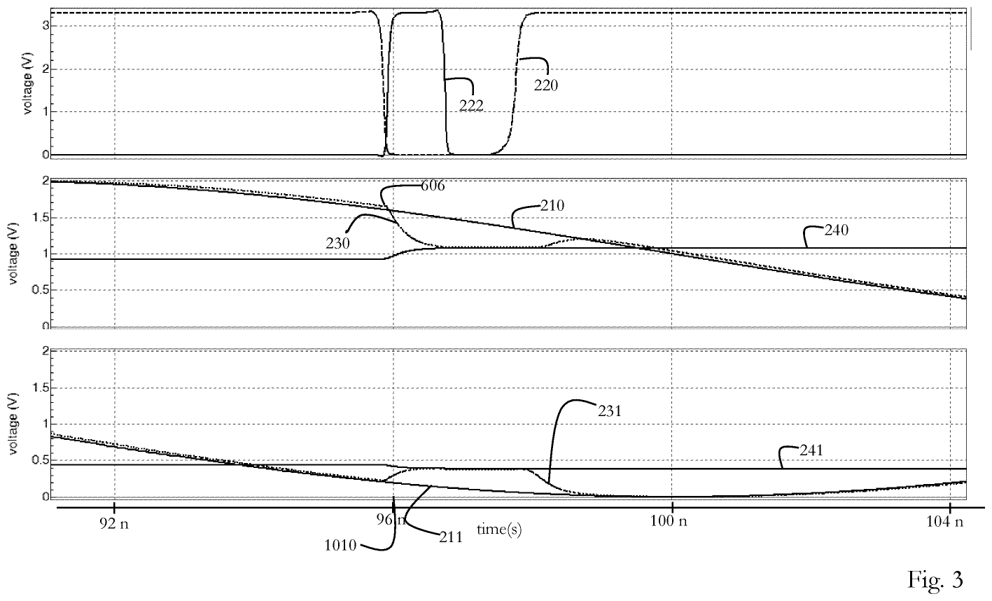

In response to each event, q6 goes low, and the switches Xa1 and Xa2 stop to conduct, leaving the voltages on nodes 112 and 113 stay at their last value. Switch control circuit 100 then causes the node voltage p6 to temporarily go high, after the signal q6 went low. There can be a time period between the going low of q6 and the going high of p6, the voltage sample will stay on nodes 112 and 113. In the example of FIG. 2 (and FIG. 3 that is a zoom in around the event around 95 ns), there is very little time present in-between these edges in this embodiment, which may be considered as not required in other embodiments).

During the period that p6 is high, there is an intended short-circuit between the capacitors Cs1 and Ci1 and between Cs2 and Ci2 due to the conduction of the switches Xb1 and Xb2 of the averaging demodulators 120 and 121, respectively.

The explanation of the operation of the averaging demodulators will be focused on the first one (averaging demodulator 120). Same understanding applies to other ones of the present disclosure, wherein potential modifications may be apparent to the person skilled in the art.

By shorting Cs1 with Ci1, the voltages on these capacitors will move towards each other, and find a common voltage depending on the capacitor ratio Ci1/Cs1. The averaging capacitor Ci1 is assumed larger to much larger, than the sampling capacitor Cs1. If the ratio is a factor of 100, when the short-circuiting happens between both, the voltage on the larger capacitor will move by about 1% towards that of the small capacitor, and the small capacitor's voltage will move for about 99% towards the larger one. Therefore, in the new average voltage on node Avg1, the latest event is taken into account for by 1%, and the history remains present for by 99%. It is possible to define a sample averaging length n as the capacitor ratio n=Ci1/Cs1. This would deliver with n equals a hundred (i.e. the capacitor ration equals a hundred) an effect of the latest hundred samples that are roughly taken into account. Hence, a more recent sample counts for 1%, whilst a sample that was sampled 99 samples ago, is accounted for, with a much smaller weight.

For illustration purposes in the simulation of FIGS. 2 and 3, a capacitor ratio of four is chosen, such that there is a sample averaging length of n equals four (without limiting the present disclosure in that regard). Just before ninety-six nanoseconds (which is marked with reference number 1010), in FIG. 3, at 606, voltage 230 on node 112 that was following the voltage 210 from node F1, stops following because voltage 220 on node q6 drops, and switch Xa1 stops conducting. Voltage 222 on node p6 then goes high, pulling voltages 230 and 240 (being the voltage on the capacitors Cs1 and Ci1), towards each other in accordance to their respective capacitive values. The high level 222 on node p6 lasts sufficiently long and goes low again dictated by the switch control circuit 100. The output voltage 240 on node Avg1 is then updated with the latest event data with a weight determined by the averaging length n.

At a later point of time, a signal 220 on node q6 goes high again, preparing for a next event to occur.

Alternative embodiments may be envisaged in which there is more than one switch between node F1 and node 112. In some embodiments, additionally or alternatively, there is more than one switch between node 112 and node Avg1.

Generally, a voltage sample is taken from the demodulation function present on node F1 onto a node 112 with a capacitance Cs1 in the response of an event, and thereafter charge-sharing with a larger capacitor Ci1 is performed by making a conductive path between the two capacitors (between nodes 112 and node Avg1).

This method of operation provides that sampling occurs at the rate of the events that are coming in.

In the embodiment which is described with respect to FIGS. 1 to 3, a time-of-flight device (or receiver) with time-of-flight circuitry described herein may be operated in extreme conditions: e.g. to average out only very few number of events (e.g. every ten microseconds an event) over extreme long periods (e.g. for over one to ten milliseconds), or to average out many events (e.g. every twenty nanoseconds an event) over extreme short periods (e.g. during microseconds).

A TOF receiver according to the present disclosure may be able to operate independently, i.e. without the need of external support since it may work close to optimal. Inherent high dynamic range (HDR) can be achieved.

The switches in the averaging demodulator 120 are NMOS pass-gates Xa1 and Xb1. In some embodiments, they are implemented as full-fledged CMOS switches with both NMOS and PMOS transistors conducting at (roughly) the same moment, or just only PMOS pass-gates (in other embodiments). Further, in order to achieve a large sample averaging length n, capacitor Cs1 can be constructed merely by a parasitic capacitance of the diffusion nodes of the connected switches Xa1 and Xb1. Further, it may be envisaged to provide Cs1 as being settable, e.g. by using a varactor, or a switch which is configured to add an additional capacitor in parallel to it. In that way, the sample averaging length n can be made settable and variable. The output averaging capacitor Ci1 may be provided in the way that is most suitable to the used chip technology, e.g. by gate capacitance, poly-poly, metal fingered, or by a capacitor that is available for implementation of a dynamic memory (e.g. metal filled trench).

Aforementioned considerations hold for the second averaging demodulator 121 with the cosine voltage at its input F2, and for all other averaging demodulators of the present disclosure. However, the present disclosure is not limited that averaging demodulators of the same embodiment of a time-of-flight circuitry are necessary envisaged to be copies of each other since every averaging demodulator may be provided individually, depending on the circumstances.

The switch control circuit 110 contains an inverter X6, as an example, to provide signal q6. The components X2, X3, X4 and X5 of FIG. 1 constitute a one-shot circuit: at the occurrence of an event, p1 goes high, and for a period of the latency of three inverters (X2, X3 and X4), p4 remains high during which the output p6 of a NAND-gate X5 gets high for about that latency period, however long enough to fulfill said charge sharing between nodes 112 and Avg1.

The switch control circuit 110 is just an example circuit, but many other circuits can achieve same or similar functionality, e.g. optimized for size but not limited thereto. In this embodiment, signals q6 and p6 should be constructed to never be high at the same time, i.e. they should be non-overlapping signals to avoid that switches Xa1 and Xb1 get conductive simultaneously thereby corrupting the output voltage on node Avg1.

In order to measure a distance based on TOF, in the case of having also BL and DCR, two measurements based on averaging demodulation may be needed. In FIG. 1 this is done in a simultaneous way, having per time-of-flight circuitry 90 two averaging demodulators 120 and 121 available.

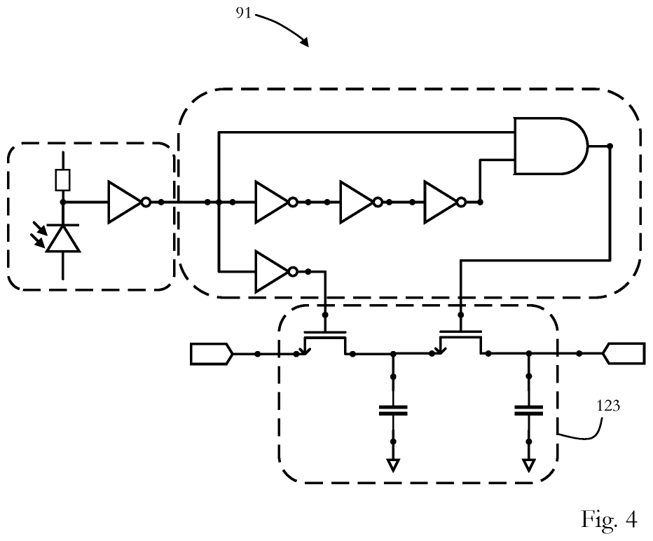

In FIG. 4, an embodiment of time-of-flight circuitry 91 (or TOF receiver) including a single averaging demodulator 123 is shown. The averaging demodulator 123 can be operated sequentially (or consecutively) in several frames, e.g. two frames: during a first frame, a first average voltage is obtained by applying a sine as demodulation function on node F1, followed by a second frame during which a second average voltage is obtained by applying a cosine as demodulation function on node F1. Both frames run the averaging demodulator 123 for e.g. several hundreds of micro-seconds each.

Time-of-flight circuitry 91 can be constructed smaller than time-of-flight circuitry 90 of FIG. 1, for example, and hence allows for higher resolutions sensor arrays.

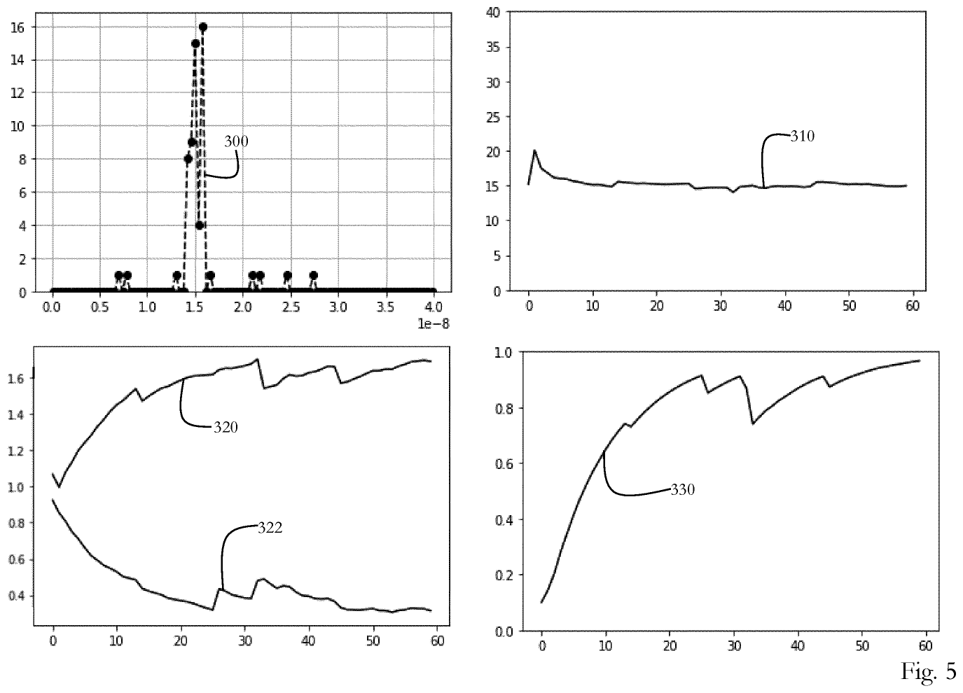

FIG. 5 shows results from simulations, illustrating the averaging demodulation principle, in this case using sine and cosine functions as voltages applied on nodes F1 and F2, respectively.

In this simulation, the sine and cosine alternate around an offset voltage of one volt, with an amplitude of one volt, as in FIG. 2. A period of forty nanoseconds is assumed, with a sample averaging length n of ten. The total length of the simulation represents sixty events, of which fifty-four events originate from TOF events, and 6 randomly from DCR and/or BL events. The sequence of arrival is randomized, as a realistic use-case. The TOF is fifteen nanoseconds, and the scene illumination light source's pulse-width is assumed two nanoseconds, something that can be achieved with a laser, for example. The fifty-four events have thus a departure time that is statistically spread over the pulse-width of two nanoseconds. In a histogram curve 300 (the histogram not being needed according to the present disclosure, but being present for this illustration, as it is typically used in known direct TOF devices) the arrival times are recorded in a hundred bins of four hundred picoseconds, equally spread over forty nanoseconds. Between fourteen and sixteen nanoseconds there are the most events recorded due to the fifteen nanoseconds time of flight and the two nanoseconds pulse-width of the laser.

The output average voltages on node Avg1 (curve 320) and node Avg2 (curve 322), have about one volt as initial condition. Curve 310 is the estimated TOF, calculated from the values of the curves 320 and 322 using the arctangent (or atan) mathematical function. Curve 330 depicts the confidence level of the measurement, by taking the RMS value of the voltages 320 and 322 (after subtraction of the one volt offset). The X-axes for curves 320, 322, 310 and 330 depict the sample event number, as they statistically come in, up to sixty events. Curves 320 and 322 converge after three to four times the sample averaging length n (i.e. thirty to forty samples) to their end-value, during (and after) which they get kicked up and down due to the 6 DL and/or DCR samples.

The calculated TOF 310, rises to a value close to the expected and applied fifteen nanoseconds TOF. Taking from samples thirty to sixty the average and the precision, the average is fourteen point nine nanoseconds, and the precision is four hundred picoseconds, being about one percent of the forty nanoseconds period. Since the sample averaging length is ten, it is possible to bring out several meaningful readouts every ten samples, which would deliver for the last thirty samples four readouts, improving in principle the precision by the root of it, so to a precision of two hundred picoseconds. Assuming each cycle is giving an event, this operation of sixty cycles would take sixty times forty nanoseconds (i.e. two-thousand four-hundred nanoseconds). If there would be no BL or DCR, and the light source pulse-width would be very small compared to the sine cycle time, a confidence level of 1 (100%) would be achieved.

In this simulation, there is ten percent of BL and/or DCR events which reduces the confidence level by ten percent. In other words, the TOF event to total event ratio is ninety percent, delivering a confidence level 330 oscillating around ninety percent. Basically, the confidence level, by taking the RMS of the values in curves 320 and 322 (reduced by the one volt offset) may be considered as the amplitude of the sine and cosine constituting one complex wave.

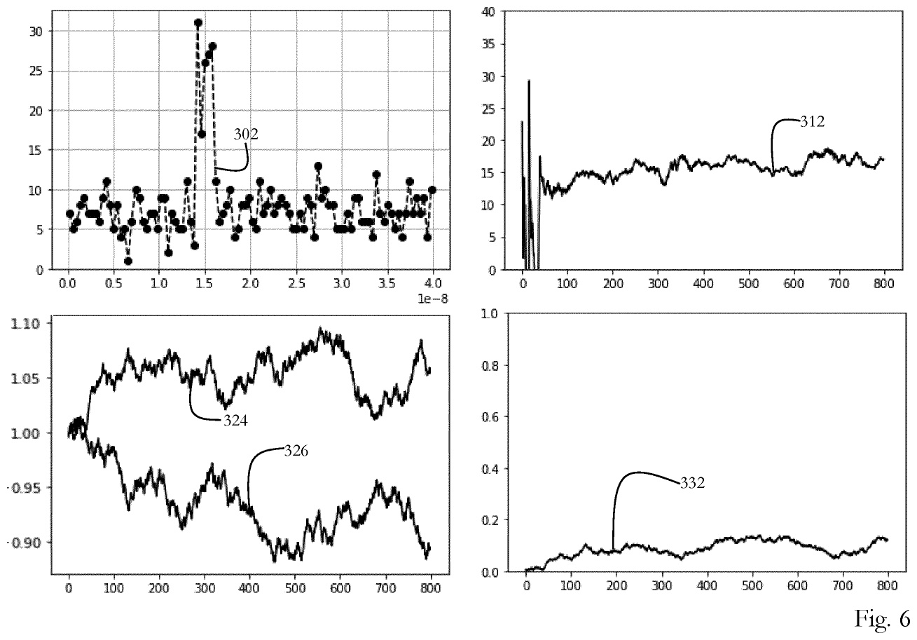

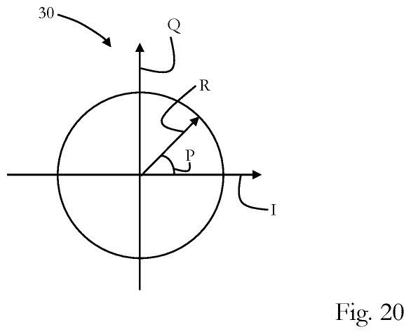

In a further simulation depicted in FIG. 6, there are nine times more BL and DCR events than there are TOF events available from a TOF reflection of the (simulated) scene: Seven hundred and twenty BL and/or DCR, events versus eighty TOF events. Hence, in this simulation, the TOF event to total event ratio is ten percent, delivering a confidence level 332 around ten percent. The TOF is again fifteen nanoseconds, and the cycle time is again forty nanoseconds, the histogram binning is again a hundred, and the light source pulse width is again two nanoseconds. The sample averaging length n is set to two hundred, such that this high noise conditions are taken into account. The histogram shows the many statistically spread events, but also the TOF events peaking between fourteen and sixteen nanoseconds. The number of TOF events is only slightly larger than in FIG. 5 (eighty versus fifty-four). Curves 324 and 326 illustrate the averaged demodulated signals from nodes F1 and F2, their amplitudes (after subtraction of one volt, as already discussed above) being reduced by the ten times higher level of noise (BL and/or DCR). The estimate TOF distance 312 based on the arctangent calculations from 324 and 326, however still gives a sufficient view of the distance estimate 312, as known for iTOF, which will be explained under reference of FIG. 20.

Although curves 324 and 326 are rather fluctuating (due to the many BL and/or DCR events), the resultant TOF curve 312 is rather stable. In the four hundred to eight hundred sample range, the average TOF is sixteen point four nanoseconds, and the precision is two point five percent of the time interval period of forty nanoseconds (i.e. one nanoseconds).

Again, reading out every two hundred samples, and averaging these readouts, improves in the second half the precision to five hundred picoseconds. The confidence level shows that the complex amplitude is reduced to ten percent, such that a connected DSP or subsequent data processor can know that the results are a bit less precise and that further averaging would probably be needed to further improving precision and accuracy of the TOF determination.

A further embodiment of time-of-flight circuitry 92 according to the present disclosure is illustrated in FIG. 7. Due to the fact that averaging demodulators can be implemented on a rather small area, it can be considered to implement more instances of them than shown in FIG. 1.

One way to exploit that option in some embodiments is to split the TOF time measurement interval into several parts, for example each of them covered by a pair of averaging demodulators. To achieve this, in some embodiments a single switch control circuit 110 is provided that is common to all averaging demodulators. In the implementation presented here, the signal p5 that executes the inclusion of the sample to the average, is gated. A first (AND-)gate 130, passes the signal p5 only when the signal on node Window1 is high. So, only events that happen when the node Window1 is high are incorporated in the attached averaging demodulators 124 and 125 by asserting the signal p61. Similarly, only events that happen when the voltage on node Window2 is high are incorporated in the attached averaging demodulators 126 and 127 by asserting the signal p62 as output of a further (AND-)gate 131.

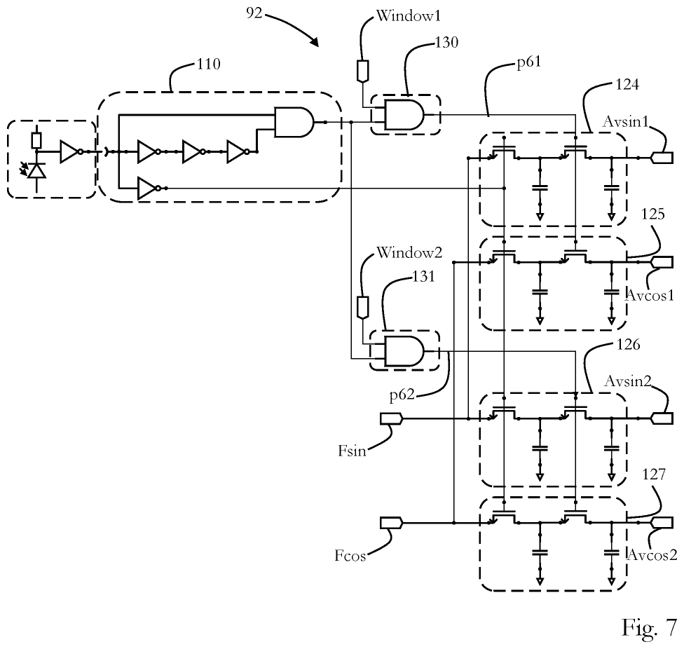

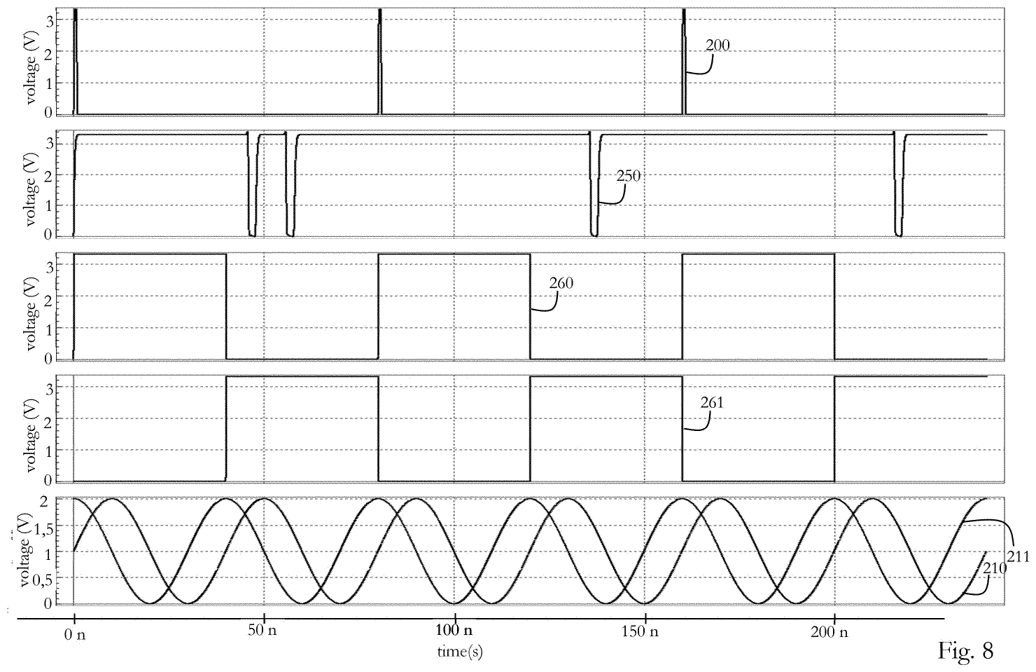

In this embodiment, as shown in FIG. 8, a signal 260 on node Window1 is high during the first forty nanoseconds, and the second signal 261 on node Window2 is high during the next forty nanoseconds. In the example curves of FIG. 8, there are only events (happening when q6 is going low, curve 250) when node Window2 is high (curve 261), and as a result, only averaging demodulators 126 and 127 get updated thereby. An attached processor may be configured to make use of the confidence level by comparing the confidence levels of each of the pairs of averaging demodulators. The RMS value of voltages on nodes AvSin1 and AvCos1 (after subtraction of their offset of one volt) will be close to zero assuming that the TOF falls into the second window and as a result the RMS value of voltages on nodes AvSin2 and AvCos2 (after one volt subtraction) will be larger. The window with the highest confidence level contains the TOF delay that is searched for, and the other pair can be ignored. When the TOF delay happens to fall at the edge between two windows, the confidence levels will become of comparable amplitude, and Avsin1 and Avsin2 can be added, and Avcos1 and Avcos2 can be added for finding with the arctangent the estimated TOF position, taking into account that the answer should also be close to the edge between these two windows. In this way, a long distance can be split into many pieces, e.g. up to twenty pieces, assuming the circuitry is in an advanced type of CMOS, in that way keeping the area for the time-of-flight circuitry 92 small enough. Moreover, according to such a window splitting, the BL and DCR also gets proportionally reduced improving accuracy and precision of a TOF measurement.

An alternative way of window splitting is to organize an overlap of windows, e.g. ten to twenty percent overlap. Provided that the scene illumination light source pulse-width is shorter in time than the overlap time, it is possible to ensure that there is always at least one window that fully covers the initial light source pulse width.

In some embodiments, the modulation function in a given window has a zero average (not taking the one volt offset into account), for accommodation of the random events, so when working e.g. with sine and cosine functions, a window may be defined as covering the full three hundred and sixty degrees (i.e. one period) (or multiples of that). The person skilled in the art will be able make the digital signal processor (DSP) find the pair having the largest confidence value and retrieve the correct phase and TOF distance according to the teaching of the present disclosure.

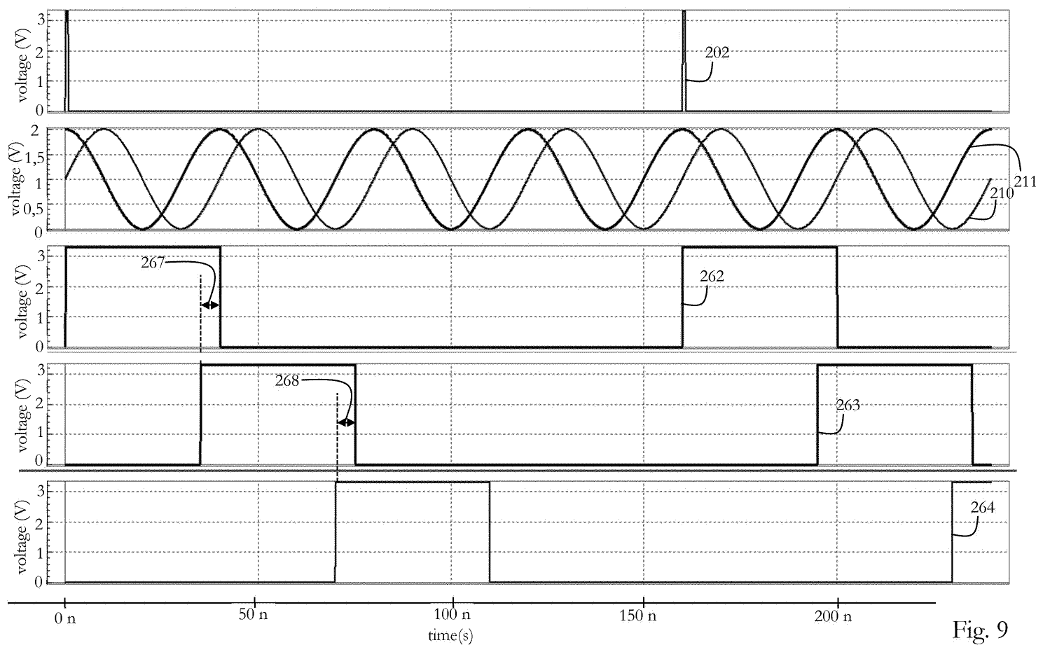

Such an embodiment is depicted in FIG. 9, showing three windows by curves 262, 263 and 264. A sine and cosine period (curves 210 and 211) are forty nanoseconds, the window periods are also forty nanoseconds, and the second window 263 overlaps (267) with the first window 262 for five nanoseconds, the third window 264 overlaps (268) with the second window 263 for five nanoseconds.

However, the present disclosure is not limited to the demodulation functions of FIG. 9, as many other demodulation functions can be utilized for the averaging demodulation principles provided in the present disclosure.

The scene illumination light source signal may be more than just a pulse, it can be itself a sine wave, or a PRBS coded wave, it can include gold codes and the like. In combination with the appropriate demodulation waveform(s) the principles of the present disclosure can be applied, even possibly local to each SPAD detector in some instances.

The idea of using windows can also be used in ways not presented here. They have the property of limiting the DCR and BL random events, which generate noise in the output. Gating windows, modulation functions, sample averaging lengths, they can be switched all the time, according to the system to be implemented. A window can slide in time, to follow an object in a way that a very low number of BL and DCR events are included in the averaged modulated output. Hence, in some embodiments, a single window, e.g. sliding in time, is implemented.

When designing a LIDAR for an environment where multiple LIDARs need to operate simultaneously and independently from each other (as may be envisaged in automotive applications), it may be desired to have a coping strategy to limit interference from each other's scene illumination light pulses and their reflections. This may be achieved by delaying each scene illumination light pulse by a (pseudo) random delay. In the present disclosure, a windowing principle can be used to accommodate such mode of operation, by using a window function to ignore any events during these delay periods (without limiting the present disclosure in that regard). However the demodulation functions may be resumed right after a delay period. In that way it is also possible that periodic demodulation functions are no longer periodic because of these additional intermediate variable random delays.

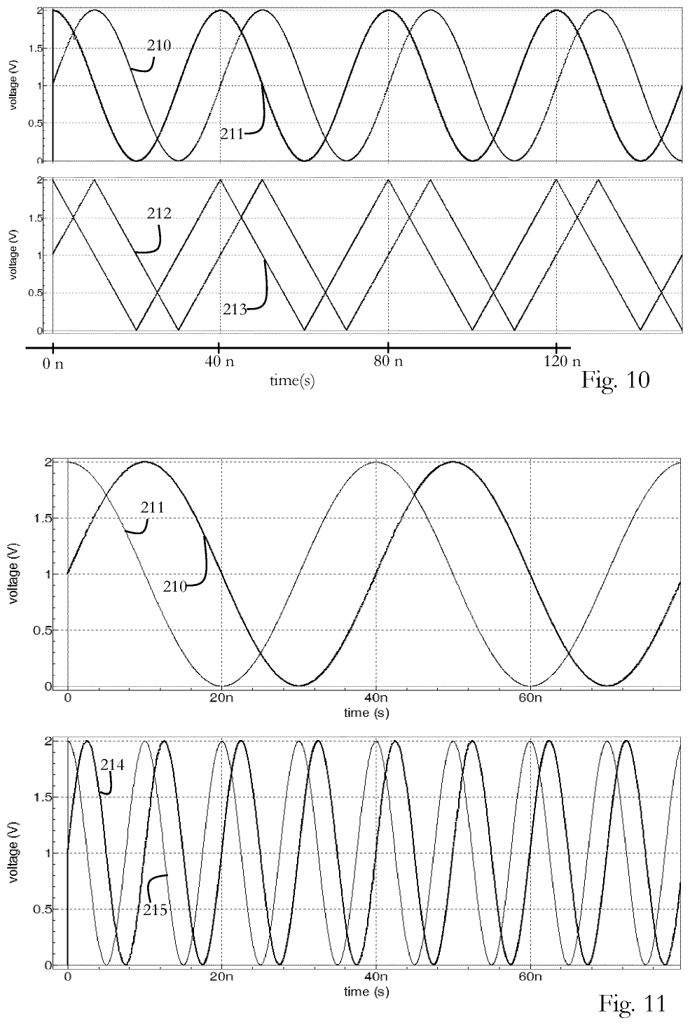

A further embodiment of a pair of demodulation functions is shown in FIG. 10. Instead of using a “real” sine 210 and cosine 211, it is possible to use triangular functions as demonstrated by curve 212 (pseudo sine) and curve 213 (pseudo cosine), respectively. It will be appreciated by the person skilled in the art that retrieving the TOF determination does not any longer involve the arctangent, but multiplications, divisions and additions instead. Also, the confidence level turns out to be easier to compute by just calculating the sum of the absolute values of the averaged outputs (instead of performing an RMS addition). The demodulation signals are also more easily constructed on chip. An example of triplet functions is a set of three sine wave functions evenly spread by one hundred and twenty degrees, giving rise to better precision and accuracy (not shown).

FIG. 11 depicts an embodiment of an application of four demodulation functions. Sine 210 and cosine 211 demodulation functions are applied as before (as depicted in the upperpart of FIG. 10, hence the reference numbers are left out); however, they are complemented by a sine 214 and a cosine 215 demodulation function having a four times higher frequency than the functions 210 and 211. All four functions can be operated on four averaging demodulators simultaneously and/or in parallel (such as in the embodiment of FIG. 7). The sine 210 and cosine 211 give a rough estimate of the position of the TOF events, and the sine 214 and cosine 215 contribute to a precision of the measurement, presumably in an increase of the precision by factor of four. The average demodulated values from the sine 214 and cosine 215 give four possible solutions in the forty nanoseconds timeframe, the average demodulated values from the sine 210 and cosine 211 will eliminate three of them by providing a crude TOF event position. The selection of which can be done in an attached DSP processor getting the four averaged demodulated signals to process.

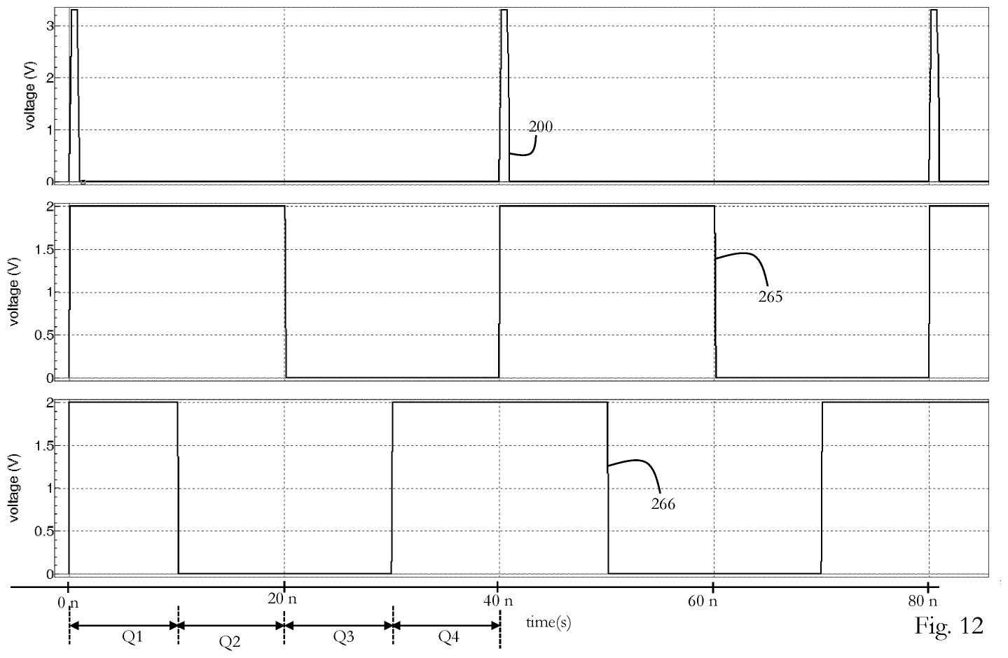

FIG. 12 shows two digital demodulation functions for roughly finding out where TOF events are located. A demodulation function 265 is high (two volts) during Q1 and Q2 and low (zero volts) during Q3 and Q4. Demodulation function 266 is high during Q1 and Q4 and low during Q2 and Q3. When TOF events are at fifteen nanoseconds (not shown), the averaged demodulated output of the demodulation function 265 will be larger than one volt, and the averaged demodulated output of the demodulation function 266 will be less than one. How much larger and less will depend on the signal to noise ratio, as discussed before. If there is no noise, two volts and zero volts will be outputted respectively. From the fact that the averaged demodulated output of the demodulation function 265 will be larger than one, and that of the demodulation function 266 will be less than one, it is concluded, in this embodiment, that TOF events are received in Q2.

In this embodiment, a rather simple comparison with IV suffices, and no higher order analog to digital converter (ADC) is needed for TOF estimation/determination. Several more demodulation functions can be added, in some embodiments, for example in a GREY-code way, i.e. whereby the edges in the demodulation functions never happen simultaneously (i.e. the demodulation functions may be shifted and altered according to a GREY-code). When each of these functions are being averaged and demodulated according to the present disclosure, and subsequently compared to the one volt threshold voltage, a digital word representing the TOF distance can be outputted without any use of ADC and/or DSP processor.

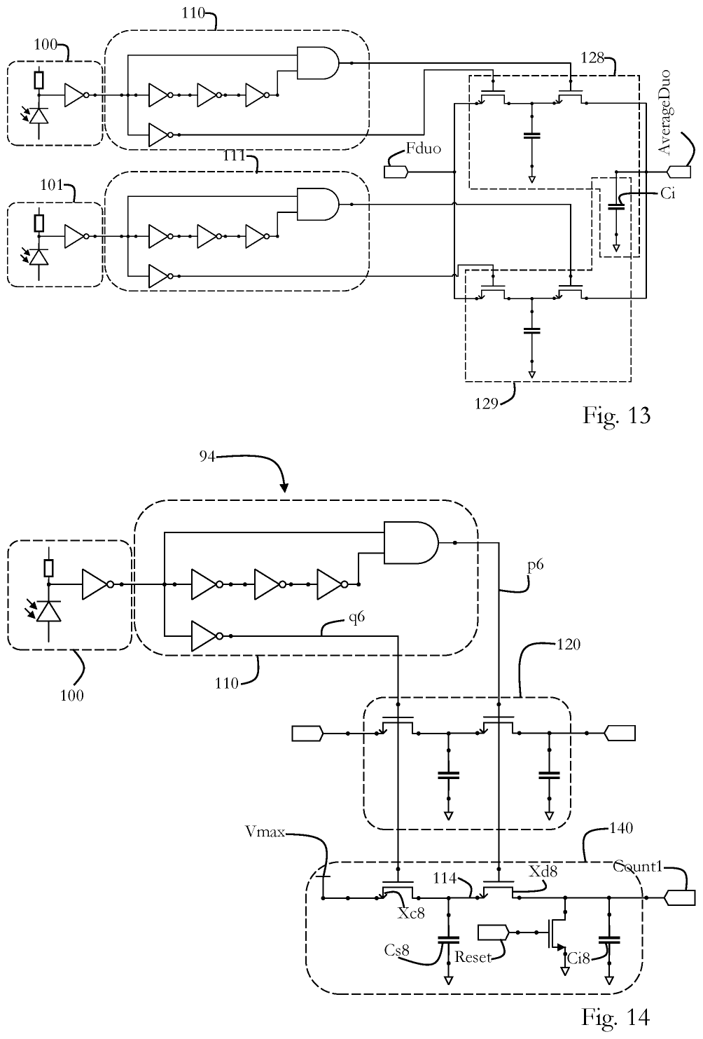

As generally known, a SPAD detector may have a “dead-time”. This may be defined as a time in which a SPAD is “blind” for new incoming events, after it had just received a photon or DCR event (i.e. new events are not detected for the dead-time after a detection). To mitigate the effects, a multitude of SPADs can be operated in parallel, such that when one SPAD was triggered, the others are still available for triggering (since the same event is not detected in the other SPAD). Together they may generate a single output. This operation principle is also taken into account in the present disclosure in which case, the principle of FIG. 13 may be utilized.

It is demonstrated here with two SPAD circuits 100 and 101, two control signal generators 100 and 101, and two averaging demodulators 128 and 129, that each operate on the same averaging capacitor Ci at the node “Averageduo” using a same demodulation function that can be applied on a node Fduo. As will be appreciated by a person skilled in the art, the system of FIG. 13 may be extended to more SPAD circuits, to the use of more demodulation functions, and to the use of any of the aforementioned windowing principles.

For some applications, it may be useful to have a measure for the incident light level input. Counting the output pulses of the SPAD circuit 100 is one option, such that all events are counted. Another option implemented in some embodiments is to gate the signal and to only include events that are in certain time windows. It is possible to consider digital and/or analog counters, each having their advantages and disadvantages, as is generally known. In case one wants to keep the occupied area by the counter rather small, the analog counter may be preferred.

In that case, as embodiment of the present disclosure, signals q6 and p6 (as described under reference of FIG. 1) from the switch control circuit 110 are reused as exemplified in FIG. 14. showing a TOF receiver 94 with an analog photon counter 140 having an asynchronous reset input. After resetting the voltage on node Count1, by pulsing the voltage on node Reset high the counting can begin. Having a high on node q6, brings the node 114 to the same voltage Vmax at the left side of the switch Xc8. When q6 drops to zero volt, Vmax voltage roughly sticks to node 114, after which switch Xd8 will temporarily conduct, for as long as the signal p6 remains high. Capacitor Cs8 being a much smaller capacitor than the output integration capacitor Ci8, will through charge sharing, bring the voltage on node Count1 up with a step depending on the voltage difference between the voltages on the nodes 114 and Count1 and the a fraction determined by the relative values of the capacitors Cs8 and Ci8.

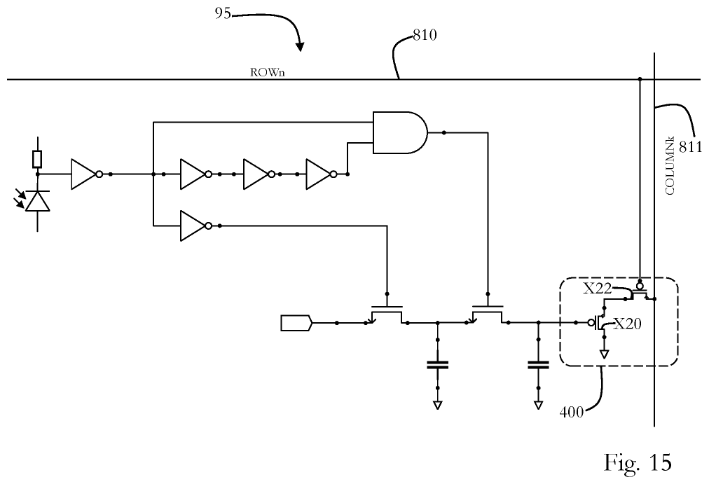

This constitutes a saturating counter, providing a larger dynamic range and is known to the person skilled in the state of the art. Pure linear counters may also (alternatively or additionally) be included, operating with fixed charge packets that are added to an output node, e.g. also driven by the same signals q6 and p6. In case one needs to count events limited to time windows, it is possible for example use q6 and p61 from FIG. 7, whereby p61 is a gated signal, limiting the increase of the counter value to events that are present only when Window1 is high. FIG. 15 illustrates a TOF receiver 95 (time-of-flight circuitry) according to the present disclosure, which is integrated with a row 810 and a column line 811 for array integration using circuit 400 (it should be noted that any of the discussed time-of-flight circuitry may generally be used in an array of multiple time-of-flight circuitries). The latter circuit contains a voltage follower transistor X20, in this example a PMOS transistor, because such transistor will perform sufficiently in a lower part of a voltage supply range. A transistor X22 serves as a pass gate and connects the output of the voltage follower X20 to the column line 811 when its gate is driven low by the row line 810.

The person skilled in the art can adapt this kind of array-connections to its preferred topology, making sure that each of the output voltages from averaging demodulators, and possibly output counters, each get connected for readout.

The transistor X20 will have a variable gate offset that may be seen as a kind of fixed pixel noise in the output read-out chain. A form of calibration can be considered to mitigate this effect. When turning off the pulsed scene illumination light source, only uncorrelated events will occur, and the output nodes of all the averaging demodulators go to their mid-state, irrespective on the level of BL, even if there is no BL, the DCR events will make the output go to its mid-state. This voltage, different for each pixel, can be used in some embodiments as a nulling reference voltage by a subsequent DSP unit, for example.

Any of the systems that are presented here, or that are based on it, can be complemented by other means known in the state of the art in image sensors. For example, it is possible to apply micro-lenses, colour filters, to improve qualitatively, or quantitatively the light input to the single photon detection circuit. Any means for improving the internal/external quantum efficiency, responsivity, and detection probability can be applied. Three-dimensional stacking can be done, e.g. whereby a SPAD detector layer stems from another wafer/material than the CMOS circuit wafer. Back-side illumination (BSI) may be applied, current assistance may be applied or a Silicon On Insulator (SOI) technology may be applied. The proposed embodiments of the present disclosure may be implemented as pixels for a sensor array, in total making a 3D image sensor. Several signals can be grouped for a plurality of pixels, or are the same for a whole array, like the ones defining the windows, demodulation functions, and signals determining the averaging-length n. In addition to all this, a standard 3T or 4T image sensor pixel can be added, for performing simultaneously standard image sensing. The SPAD circuit 100 may contain a regular SPAD, but can also contain any other means to achieve single photon detection, including an avalanche photodetector (APD) with a gain, such that it is possible to use a linear gain modus to operate the diode below break-down and still achieve digital photon arrival edges and events.

The technology according to an embodiment of the present disclosure is applicable to various products. For example, the technology according to an embodiment of the present disclosure may be implemented as a device included in a mobile body that is any of kinds of automobiles, electric vehicles, hybrid electric vehicles, motorcycles, bicycles, personal mobility vehicles, airplanes, drones, ships, robots, construction machinery, agricultural machinery (tractors), and the like.

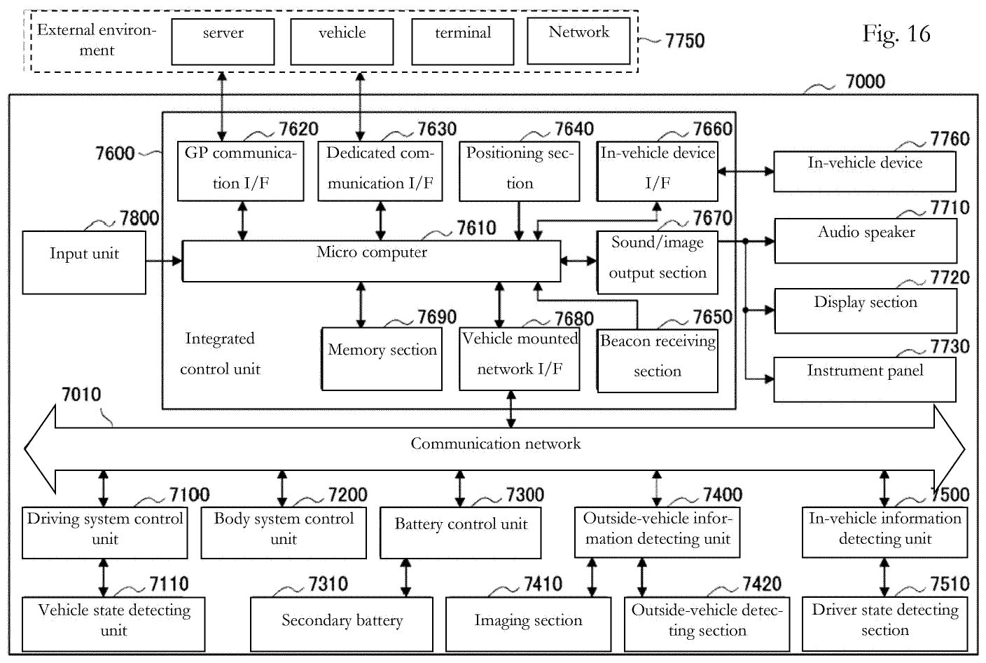

FIG. 16 is a block diagram depicting an example of schematic configuration of a vehicle control system 7000 as an example of a mobile body control system to which the technology according to an embodiment of the present disclosure can be applied. The vehicle control system 7000 includes a plurality of electronic control units connected to each other via a communication network 7010. In the example depicted in FIG. 16, the vehicle control system 7000 includes a driving system control unit 7100, a body system control unit 7200, a battery control unit 7300, an outside-vehicle information detecting unit 7400, an in-vehicle information detecting unit 7500, and an integrated control unit 7600. The communication network 7010 connecting the plurality of control units to each other may, for example, be a vehicle-mounted communication network compliant with an arbitrary standard such as controller area network (CAN), local interconnect network (LIN), local area network (LAN), FlexRay (registered trademark), or the like.

Each of the control units includes: a microcomputer that performs arithmetic processing according to various kinds of programs; a storage section that stores the programs executed by the microcomputer, parameters used for various kinds of operations, or the like; and a driving circuit that drives various kinds of control target devices. Each of the control units further includes: a network interface (I/F) for performing communication with other control units via the communication network 7010; and a communication I/F for performing communication with a device, a sensor, or the like within and without the vehicle by wire communication or radio communication. A functional configuration of the integrated control unit 7600 illustrated in FIG. 16 includes a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690. The other control units similarly include a microcomputer, a communication I/F, a storage section, and the like.

The driving system control unit 7100 controls the operation of devices related to the driving system of the vehicle in accordance with various kinds of programs. For example, the driving system control unit 7100 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like. The driving system control unit 7100 may have a function as a control device of an antilock brake system (ABS), electronic stability control (ESC), or the like.

The driving system control unit 7100 is connected with a vehicle state detecting section 7110. The vehicle state detecting section 7110, for example, includes at least one of a gyro sensor that detects the angular velocity of axial rotational movement of a vehicle body, an acceleration sensor that detects the acceleration of the vehicle, and sensors for detecting an amount of operation of an accelerator pedal, an amount of operation of a brake pedal, the steering angle of a steering wheel, an engine speed or the rotational speed of wheels, and the like. The driving system control unit 7100 performs arithmetic processing using a signal input from the vehicle state detecting section 7110, and controls the internal combustion engine, the driving motor, an electric power steering device, the brake device, and the like.

The body system control unit 7200 controls the operation of various kinds of devices provided to the vehicle body in accordance with various kinds of programs. For example, the body system control unit 7200 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 7200. The body system control unit 7200 receives these input radio waves or signals, and controls a door lock device, the power window device, the lamps, or the like of the vehicle.

The battery control unit 7300 controls a secondary battery 7310, which is a power supply source for the driving motor, in accordance with various kinds of programs. For example, the battery control unit 7300 is supplied with information about a battery temperature, a battery output voltage, an amount of charge remaining in the battery, or the like from a battery device including the secondary battery 7310. The battery control unit 7300 performs arithmetic processing using these signals, and performs control for regulating the temperature of the secondary battery 7310 or controls a cooling device provided to the battery device or the like.

The outside vehicle information detecting unit 7400 detects information about the outside of the vehicle including the vehicle control system 7000. For example, the outside-vehicle information detecting unit 7400 is connected with at least one of an imaging section 7410 and an outside-vehicle information detecting section 7420. The imaging section 7410 includes at least one of a time-of-flight camera adapting time-of-flight circuitry according to the present disclosure, a stereo camera, a monocular camera, an infrared camera, and other cameras. The outside-vehicle information detecting section 7420, for example, includes at least one of an environmental sensor for detecting current atmospheric conditions or weather conditions and a peripheral information detecting sensor for detecting another vehicle, an obstacle, a pedestrian, or the like on the periphery of the vehicle including the vehicle control system 7000.

The environmental sensor, for example, may be at least one of a rain drop sensor detecting rain, a fog sensor detecting a fog, a sunshine sensor detecting a degree of sunshine, and a snow sensor detecting a snowfall. The peripheral information detecting sensor may be at least one of an ultrasonic sensor, a radar device, and a LIDAR device (Light detection and Ranging device, or Laser imaging detection and ranging device) which are based on time-of-flight circuitry according to the present disclosure. Each of the imaging section 7410 and the outside-vehicle information detecting section 7420 may be provided as an independent sensor or device, or may be provided as a device in which a plurality of sensors or devices are integrated.

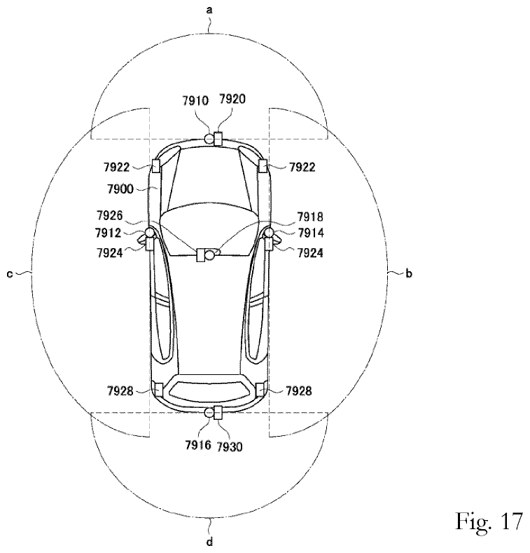

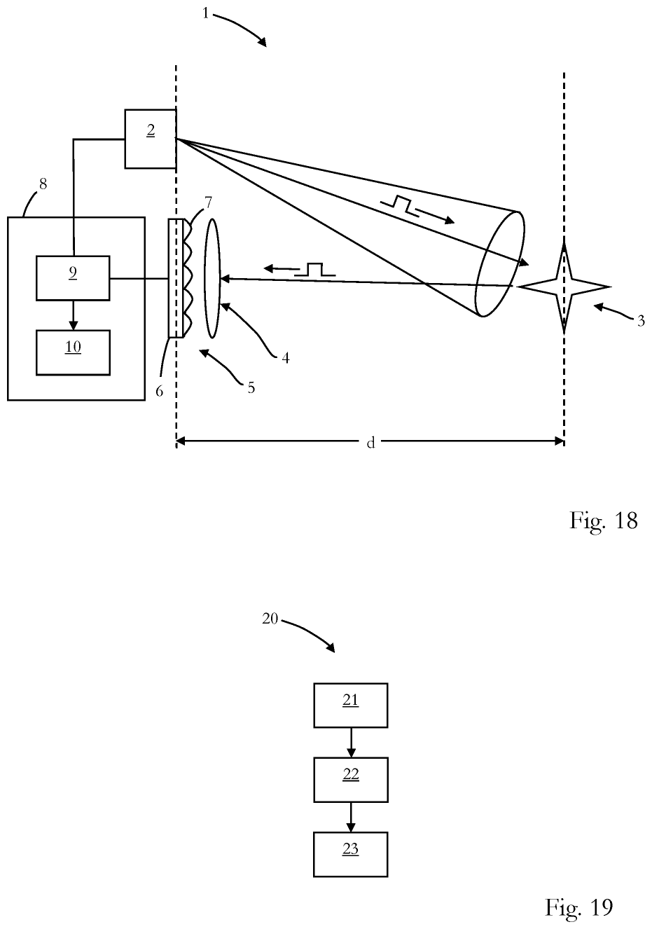

FIG. 17 depicts an example of installation positions of the imaging section 7410 and the outside-vehicle information detecting section 7420. Imaging sections 7910, 7912, 7914, 7916, and 7918 are, for example, disposed at at least one of positions on a front nose, sideview mirrors, a rear bumper, and a back door of the vehicle 7900 and a position on an upper portion of a windshield within the interior of the vehicle. The imaging section 7910 provided to the front nose and the imaging section 7918 provided to the upper portion of the windshield within the interior of the vehicle obtain mainly an image of the front of the vehicle 7900. The imaging sections 7912 and 7914 provided to the sideview mirrors obtain mainly an image of the sides of the vehicle 7900. The imaging section 7916 provided to the rear bumper or the back door obtains mainly an image of the rear of the vehicle 7900. The imaging section 7918 provided to the upper portion of the windshield within the interior of the vehicle is used mainly to detect a preceding vehicle, a pedestrian, an obstacle, a signal, a traffic sign, a lane, or the like.

Incidentally, FIG. 17 depicts an example of photographing ranges of the respective imaging sections 7910, 7912, 7914, and 7916. An imaging range a represents the imaging range of the imaging section 7910 provided to the front nose. Imaging ranges b and c respectively represent the imaging ranges of the imaging sections 7912 and 7914 provided to the sideview mirrors. An imaging range d represents the imaging range of the imaging section 7916 provided to the rear bumper or the back door. A bird's-eye image of the vehicle 7900 as viewed from above can be obtained by superimposing image data imaged by the imaging sections 7910, 7912, 7914, and 7916, for example.

Outside-vehicle information detecting sections 7920, 7922, 7924, 7926, 7928, and 7930 provided to the front, rear, sides, and corners of the vehicle 7900 and the upper portion of the windshield within the interior of the vehicle may be, for example, an ultrasonic sensor or a radar device. The outside-vehicle information detecting sections 7920, 7926, and 7930 provided to the front nose of the vehicle 7900, the rear bumper, the back door of the vehicle 7900, and the upper portion of the windshield within the interior of the vehicle may be a LIDAR device, for example. These outside-vehicle information detecting sections 7920 to 7930 are used mainly to detect a preceding vehicle, a pedestrian, an obstacle, or the like.

Returning to FIG. 16, the description will be continued. The outside-vehicle information detecting unit 7400 makes the imaging section 7410 image an image of the outside of the vehicle, and receives imaged image data. In addition, the outside-vehicle information detecting unit 7400 receives detection information from the outside-vehicle information detecting section 7420 connected to the outside-vehicle information detecting unit 7400. In a case where the outside-vehicle information detecting section 7420 is an ultrasonic sensor, a radar device, or a LIDAR device, the outside-vehicle information detecting unit 7400 transmits an ultrasonic wave, an electromagnetic wave, or the like, and receives information of a received reflected wave. On the basis of the received information, the outside-vehicle information detecting unit 7400 may perform processing of detecting an object such as a human, a vehicle, an obstacle, a sign, a character on a road surface, or the like, or processing of detecting a distance thereto. The outside-vehicle information detecting unit 7400 may perform environment recognition processing of recognizing a rainfall, a fog, road surface conditions, or the like on the basis of the received information. The outside-vehicle information detecting unit 7400 may calculate a distance to an object outside the vehicle on the basis of the received information.

In addition, on the basis of the received image data, the outside-vehicle information detecting unit 7400 may perform image recognition processing of recognizing a human, a vehicle, an obstacle, a sign, a character on a road surface, or the like, or processing of detecting a distance thereto. The outside-vehicle information detecting unit 7400 may subject the received image data to processing such as distortion correction, alignment, or the like, and combine the image data imaged by a plurality of different imaging sections 7410 to generate a bird's-eye image or a panoramic image. The outside-vehicle information detecting unit 7400 may perform viewpoint conversion processing using the image data imaged by the imaging section 7410 including the different imaging parts.

The in-vehicle information detecting unit 7500 detects information about the inside of the vehicle. The in-vehicle information detecting unit 7500 is, for example, connected with a driver state detecting section 7510 that detects the state of a driver. The driver state detecting section 7510 may include a camera that images the driver, a biosensor that detects biological information of the driver, a microphone that collects sound within the interior of the vehicle, or the like. The biosensor is, for example, disposed in a seat surface, the steering wheel, or the like, and detects biological information of an occupant sitting in a seat or the driver holding the steering wheel. On the basis of detection information input from the driver state detecting section 7510, the in-vehicle information detecting unit 7500 may calculate a degree of fatigue of the driver or a degree of concentration of the driver, or may determine whether the driver is dozing. The in-vehicle information detecting unit 7500 may subject an audio signal obtained by the collection of the sound to processing such as noise canceling processing or the like.

The integrated control unit 7600 controls general operation within the vehicle control system 7000 in accordance with various kinds of programs. The integrated control unit 7600 is connected with an input section 7800. The input section 7800 is implemented by a device capable of input operation by an occupant, such, for example, as a touch panel, a button, a microphone, a switch, a lever, or the like. The integrated control unit 7600 may be supplied with data obtained by voice recognition of voice input through the microphone. The input section 7800 may, for example, be a remote control device using infrared rays or other radio waves, or an external connecting device such as a mobile telephone, a personal digital assistant (PDA), or the like that supports operation of the vehicle control system 7000. The input section 7800 may be, for example, a camera. In that case, an occupant can input information by gesture. Alternatively, data may be input which is obtained by detecting the movement of a wearable device that an occupant wears. Further, the input section 7800 may, for example, include an input control circuit or the like that generates an input signal on the basis of information input by an occupant or, the like using the above-described input section 7800, and which outputs the generated input signal to the integrated control unit 7600. An occupant or the like inputs various kinds of data or gives an instruction for processing operation to the vehicle control system 7000 by operating the input section 7800.

The storage section 7690 may include a read only memory (ROM) that stores various kinds of programs executed by the microcomputer and a random access memory (RAM) that stores various kinds of parameters, operation results, sensor values, or the like. In addition, the storage section 7690 may be implemented by a magnetic storage device such as a hard disc drive (HDD) or the like, a semiconductor storage device, an optical storage device, a magneto-optical storage device, or the like.

The general-purpose communication I/F 7620 is a communication I/F used widely, which communication I/F mediates communication with various apparatuses present in an external environment 7750. The general-purpose communication I/F 7620 may implement a cellular communication protocol such as global system for mobile communications (GSM (registered trademark)), worldwide interoperability for microwave access (WiMAX (registered trademark)), long term evolution (LTE (registered trademark)), LTE-advanced (LTE-A), or the like, or another wireless communication protocol such as wireless LAN (referred to also as wireless fidelity (Wi-Fi (registered trademark)), Bluetooth (registered trademark), or the like. The general-purpose communication I/F 7620 may, for example, connect to an apparatus (for example, an application server or a control server) present on an external network (for example, the Internet, a cloud network, or a company-specific network) via a base station or an access point. In, addition, the general-purpose communication I/F 7620 may connect to a terminal present in the vicinity of the vehicle (which terminal is, for example, a terminal of the driver, a pedestrian, or a store, or a machine type communication (MTC) terminal) using a peer to peer (P2P) technology, for example.

The dedicated communication I/F 7630 is a communication I/F that supports a communication protocol developed for use in vehicles. The dedicated communication I/F 7630 may implement a standard protocol such, for example, as wireless access in vehicle environment (WAVE), which is a combination of institute of electrical and electronic engineers (IEEE) 802.11p as a lower layer and IEEE 1609 as a higher layer, dedicated short range communications (DSRC), or a cellular communication protocol. The dedicated communication I/F 7630 typically carries out V2X communication as a concept including one or more of communication between a vehicle and a vehicle (Vehicle to Vehicle), communication between a road and a vehicle (Vehicle to Infrastructure), communication between a vehicle and a home (Vehicle to Home), and communication between a pedestrian and a vehicle (Vehicle to Pedestrian).

The positioning section 7640, for example, performs positioning by receiving a global navigation satellite system (GNSS) signal from a GNSS satellite (for example, a GPS signal from a global positioning system (GPS) satellite), and generates positional information including the latitude, longitude, and altitude of the vehicle. Incidentally, the positioning section 7640 may identify a current position by exchanging signals with a wireless access point, or may obtain the positional information from a terminal such as a mobile telephone, a personal handyphone system (PHS), or a smart phone that has a positioning function.

The beacon receiving section 7650, for example, receives a radio wave or an electromagnetic wave transmitted from a radio station installed on a road or the like, and thereby obtains information about the current position, congestion, a closed road, a necessary time, or the like. Incidentally, the function of the beacon receiving section 7650 may be included in the dedicated communication I/F 7630 described above.

The in-vehicle device I/F 7660 is a communication interface that mediates connection between the microcomputer 7610 and various in-vehicle devices 7760 present within the vehicle. The in-vehicle device I/F 7660 may establish wireless connection using a wireless communication protocol such as wireless LAN, Bluetooth (registered trademark), near field communication (NFC), or wireless universal serial bus (WUSB). In addition, the in-vehicle device I/F 7660 may establish wired connection by universal serial bus (USB), high-definition multimedia interface (HDMI (registered trademark)), mobile high-definition link (MHL), or the like via a connection terminal (and a cable if necessary) not depicted in the figures. The in-vehicle devices 7760 may, for example, include at least one of a mobile device and a wearable device possessed by an occupant and an information device carried into or attached to the vehicle. The in-vehicle devices 7760 may also include a navigation device that searches for a path to an arbitrary destination. The in-vehicle device I/F 7660 exchanges control signals or data signals with these in-vehicle devices 7760.

The vehicle-mounted network I/F 7680 is an interface that mediates communication between the microcomputer 7610 and the communication network 7010. The vehicle-mounted network I/F 7680 transmits and receives signals or the like in conformity with a predetermined protocol supported by the communication network 7010.

The microcomputer 7610 of the integrated control unit 7600 controls the vehicle control system 7000 in accordance with various kinds of programs on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. For example, the microcomputer 7610 may calculate a control target value for the driving force generating device, the steering mechanism, or the braking device on the basis of the obtained information about the inside and outside of the vehicle, and output a control command to the driving system control unit 7100. For example, the microcomputer 7610 may perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like. In addition, the microcomputer 7610 may perform cooperative control intended for automatic driving, which makes the vehicle to travel autonomously without depending on the operation of the driver, or the like, by controlling the driving force generating device, the steering mechanism, the braking device, or the like on the basis of the obtained information about the surroundings of the vehicle.

The microcomputer 7610 may generate three-dimensional distance information between the vehicle and an object such as a surrounding structure, a person, or the like, and generate local map information including information about the surroundings of the current position of the vehicle, on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. In addition, the microcomputer 7610 may predict danger such as collision of the vehicle, approaching of a pedestrian or the like, an entry to a closed road, or the like on the basis of the obtained information, and generate a warning signal. The warning signal may, for example, be a signal for producing a warning sound or lighting a warning lamp.

The sound/image output section 7670 transmits an output signal of at least one of a sound and an image to an output device capable of visually or auditorily notifying information to an occupant of the vehicle or the outside of the vehicle. In the example of FIG. 16, an audio speaker 7710, a display section 7720, and an instrument panel 7730 are illustrated as the output device. The display section 7720 may, for example, include at least one of an on-board display and a head-up display. The display section 7720 may have an augmented reality (AR) display function. The output device may be other than these devices, and may be another device such as headphones, a wearable device such as an eyeglass type display worn by an occupant or the like, a projector, a lamp, or the like. In a case where the output device is a display device, the display device visually displays results obtained by various kinds of processing performed by the microcomputer 7610 or information received from another control unit in various forms such as text, an image, a table, a graph, or the like. In addition, in a case where the output device, is an audio output device, the audio output device converts an audio signal constituted of reproduced audio data or sound data or the like into an analog signal, and auditorily outputs the analog signal.

Incidentally, at least two control units connected to each other via the communication network 7010 in the example depicted in FIG. 16 may be integrated into one control unit. Alternatively, each individual control unit may include a plurality of control units. Further, the vehicle control system 7000 may include another control unit not depicted in the figures. In addition, part or the whole of the functions performed by one of the control units in the above description may be assigned to another control unit. That is, predetermined arithmetic processing may be performed by any of the control units as long as information is transmitted and received via the communication network 7010. Similarly, a sensor or a device connected to one of the control units may be connected to another control unit, and a plurality of control units may mutually transmit and receive detection information via the communication network 7010.

Incidentally, a computer program for realizing the functions of the information processing device 100 according to the present embodiment can be implemented in one of the control units or the like. In addition, a computer readable recording medium storing such a computer program can also be provided. The recording medium is, for example, a magnetic disk, an optical disk, a magneto-optical disk, a flash memory, or the like. In addition, the above-described computer program may be distributed via a network, for example, without the recording medium being used.

In the vehicle control system 7000 described above, time-of-flight circuitry 90 to 95, as described herein can be applied to the integrated control unit 7600 in the application example depicted in FIG. 16.

In addition, at least part of the constituent elements of the time-of-flight circuitry 90 to 95 may be implemented in a module (for example, an integrated circuit module formed with a single die) for the integrated control unit 7600 depicted in FIG. 16. Alternatively, any of the time-of-flight circuitries 90 to 95 may be implemented by a plurality of control units of the vehicle control system 7000 depicted in FIG. 16.

In FIG. 19, on a high level, there is illustrated an embodiment of TOF apparatus (system) (e.g. included in a smartphone or mobile phone), which can be used for depth sensing or providing a distance measurement and which has time-of-flight circuitry 8 which is configured to perform the methods as discussed herein and which forms a control of the TOF apparatus 1 (and it includes, not shown, corresponding processors, memory and storage as it is generally known to the skilled person).

The ToF apparatus 1 has a pulsed light source 2 and it includes light emitting elements (based on laser diodes), wherein in the present embodiment, the light emitting elements are narrow band laser elements.

The light source 2 emits pulsed light to a scene 3 (region of interest or object), which reflects the light. By repeatedly emitting light to the scene 3, the scene 3 can be scanned, as it is generally known to the skilled person. The reflected light is focused by an optical stack 4 to a light detector 5.

The light detector 5 has an image sensor 6, which is implemented based on multiple SPADs formed in an array of pixels (light detection elements) and a microlens array 7 which focuses the light reflected from the scene 3 to the image sensor 6 (to each pixel of the image sensor 6).

The light emission time information is fed from the light source 2 to the circuitry or control 8 including a time-of-flight measurement unit 9, which also receives respective time information from the image sensor 6, when the light is detected which is reflected from the scene 3. On the basis of the emission time information received from the light source 2 and the time of arrival information received from the image sensor 6, the time-of-flight measurement unit 9 processes an avalanche signal with demodulation functions, as discussed herein, and on the basis thereon it computes a distance d (depth information) between the image sensor 6 and the scene 3, as discussed herein by implementing a time-of-flight method according to the present disclosure.

The depth information is fed from the time-of-flight measurement unit 9 to a 3D image reconstruction unit 10 of the circuitry 8, which reconstructs (generates) a 3D image of the scene 3, based on the depth information received from the time-of-flight measurement unit 9.

In the TOF sensor, the time of laser light flight is acquired by detecting an event, e.g. detected photon, when the light returns to the sensor and is detected by the sensor.

FIG. 19 depicts a time-of-flight method 20 according to the present disclosure in a block diagram.

In 21, an avalanche signal is obtained which is representative of a light detection event, as discussed herein.

In 22, the avalanche signal is processed on the basis of at least one alternating demodulation signal for correlating the avalanche signal with the light detection event, as discussed herein. In particular, in this embodiment, a sine and a cosine function are applied as alternating demodulation signals.

In 23, the voltage is saved in at least one capacitor, as discussed herein. In particular, I this embodiment, two capacitors are utilized as depicted in the embodiment of the time-of-flight circuitry 90 of FIG. 1.

FIG. 20 depicts a graph 30 of a unit circle for determining a phase and a confidence as it is generally known from iTOF.

In iTOF, demodulating typically results in a generation of I and Q values (depicted on the x-axis and the y-axis of the graph 30)

However, according to the present disclosure, a similar relation can be used. A confidence of the measurement is displayed with the arrow R, wherein the length of the arrow R represents the confidence of the measurement. Moreover, a phase P between the arrow R and the x-axis represents the phase-shift of detected light.

The phase P is given by:

$$P = arctan ( \frac{Q}{I} ) ,$$

$$Q = Voltage on node Avg 1 - offset voltage ,$$

$$I = Voltage on node Avg 2 - offset voltage .$$

Here, Q is the quadrature component and I is the in-phase component, which are together the phase component values of a pixel (IQ value). An offset voltage is subtracted from the node voltages on Avg1 and Avg2, in the operation as illustrated in FIGS. 1 to 6, this offset is set to 1V.

Then, the distance d to the object is given by:

$$d = \frac{c}{2} \cdot \frac{P}{2 π \cdot f}$$

wherein c is the speed of light, and f the demodulation frequency of the used demodulation sine and cosine functions. The amplitude of the light reflected signal RL is proportional to the amplitude value, wherein the amplitude value (amplitude) is given by:

amplitude of R=\sqrt{I²+Q²}.

The amplitude, as aforementioned, is a measure for the confidence of the measurement.

Dividing the saved voltage value based on the sine function with the saved voltage value based on the cosine function, it may be concluded to the distance of the scene, since the arctangent applied to this quotient is proportional to this distance.

It should be recognized that the embodiments describe methods with an exemplary ordering of method steps. The specific ordering of method steps is however given for illustrative purposes only and should not be construed as binding. For example, the ordering of 22 and 23 in the embodiment of FIG. 19 may be exchanged. Other changes of the ordering of method steps may be apparent to the skilled person.

Please note that the division of any of the time-of-flight circuitries 90 to 95 into respective units is only made for illustration purposes and that the present disclosure is not limited to any specific division of functions in specific units. For instance, the time-of-flight circuitries 90 to 95 could be implemented by a respective programmed processor, field programmable gate array (FPGA) and the like.

In some embodiments, also a non-transitory computer-readable recording medium is provided that stores therein a computer program product, which, when executed by a processor, such as the processor described above, causes the method described to be performed.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.
(1) Time-of-flight circuitry configured to:
   obtain an avalanche signal, which is representative of a light detection event; and
   process the avalanche signal on the basis of at least one alternating demodulation signal for correlating the avalanche signal with the light detection event.
(2) The time-of-flight circuitry of (1), further configured to: save a point of time of the light detection event as a voltage.
(3) The time-of-flight circuitry of (2), wherein the voltage is saved in at least one capacitor.
(4) The time-of-flight circuitry of (3), wherein the voltage is saved in a first capacitor in response to a shorting of the first capacitor with a second capacitor for reducing a noise of the avalanche signal.
(5) The time-of-flight circuitry of anyone of (1) to (4), wherein the at least one demodulation signal includes a first and a second demodulation signal, which are phase-shifted with respect to each other.
(6) The time-of-flight circuitry of (5), wherein the first and the second demodulation signal are based on a trigonometric function.
(7) The time-of-flight circuitry of anyone of (5) and (6), wherein the first and the second demodulation signal are applied simultaneously.
(8) The time-of-flight circuitry of anyone of (5) and (6), wherein the first and the second demodulation signal are applied consecutively.
(9) The time-of-flight circuitry of anyone of (1) to (8), further configured to:
   process the avalanche signal based on a windowing.
(10) The time-of-flight circuitry of anyone of (1) to (9), wherein the light detection event is indicative of a point of time of light being incident on a light event detector.
(11) The time-of-flight circuitry of anyone of (1) to (10), wherein the at least one alternating demodulation signal includes a periodic demodulation signal.
(12) A time-of-flight method comprising:
   obtaining an avalanche signal, which is representative of a light detection event; and
   processing the avalanche signal on the basis of at least one alternating demodulation signal for correlating the avalanche signal with the light detection event.
(13) The time-of-flight method of (12), further comprising: saving a point, of time of the light detection event as a voltage.
(14) The time-of-flight method of (13), wherein the voltage is saved in at least one capacitor.
(15) The time-of-flight method of (14), wherein the voltage is saved in a first capacitor in response to a shorting of the first capacitor with a second capacitor for reducing a noise of the avalanche signal.
(16) The time-of-flight method of anyone of (12) to (15), wherein the at least one demodulation signal includes a first and a second demodulation signal, which are phase-shifted with respect to each other.
(17) The time-of-flight method of (16), wherein the first and the second demodulation signal are based on a trigonometric function.
(18) The time-of-flight method of anyone of (16) and (7), wherein the first and the second demodulation signal are applied simultaneously.
(19) The time-of-flight method of (16) and (17), wherein the first and the second demodulation signal are applied consecutively.
(20) The time-of-flight method of anyone of (12) to (19), further comprising:
   processing the avalanche signal based on a windowing.
(21) The time-of-flight method of anyone of (12) to (20), wherein the light detection event is indicative of a point of time of light being incident on a light event detector.
(22) The time-of-flight method of anyone of (12) to (21), wherein the at least one alternating demodulation signal includes a periodic demodulation signal.
(21) A computer program comprising program code causing a computer to perform the according to anyone of (11) to (20), when being carried out on a computer.
(22) A non-transitory computer-readable recording medium that stores therein a computer program product, which, when executed by a processor, causes the method according to anyone of (11) to (20) to be performed.

1. Time-of-flight circuitry configured to:
obtain an avalanche signal, which is representative of a light detection event; and
process the avalanche signal on the basis of at least one alternating demodulation signal for correlating the avalanche signal with the light detection event.

2. The time-of-flight circuitry of claim 1, further configured to: save a point of time of the light detection event as a voltage.

3. The time-of-flight circuitry of claim 2, wherein the voltage is saved in at least one capacitor.

4. The time-of-flight circuitry of claim 3, wherein the voltage is saved in a first capacitor in response to a shorting of the first capacitor with a second capacitor for reducing a noise of the avalanche signal.

5. The time-of-flight circuitry of claim 1, wherein the at least one demodulation signal includes a first and a second demodulation signal, which are phase-shifted with respect to each other.

6. The time-of-flight circuitry of claim 5, wherein the first and the second demodulation signal are based on a trigonometric function.

7. The time-of-flight circuitry of claim 5, wherein the first and the second demodulation signal are applied simultaneously.

8. The time-of-flight circuitry of claim 5, wherein the first and the second demodulation signal are applied consecutively.

9. The time-of-flight circuitry of claim 1, further configured to:
process the avalanche signal based on a windowing.

10. The time-of-flight circuitry of claim 1, wherein the light detection event is indicative of a point of time of light being incident on a light event detector.

11. A time-of-flight method comprising:
obtaining an avalanche signal, which is representative of a light detection event; and
processing the avalanche signal on the basis of at least one alternating demodulation signal for correlating the avalanche signal with the light detection event.

12. The time-of-flight method of claim 11, further comprising: saving a point of time of the light detection event as a voltage.

13. The time-of-flight method of claim 12, wherein the voltage is saved in at least one capacitor.

14. The time-of-flight method of claim 13, wherein the voltage is saved in a first capacitor in response to a shorting of the first capacitor with a second capacitor for reducing a noise of the avalanche signal. The time-of-flight method of claim 11, wherein the at least one demodulation signal includes a first and a second demodulation signal, which are phase-shifted with respect to each other.

16. The time-of-flight method of claim 15, wherein the first and the second demodulation signal are based on a trigonometric function.

17. The time-of-flight method of claim 15, wherein the first and the second demodulation signal are applied simultaneously.

18. The time-of-flight method of claim 15, wherein the first and the second demodulation signal are applied consecutively.

19. The time-of-flight method of claim 11, further comprising:
processing the avalanche signal based on a windowing.

20. The time-of-flight method of claim 11, wherein the light detection event is indicative of a point of time of light being incident on a light event detector.
